(19) United States
(12) Patent Application Publication
(10) Pub. No.: US 2026/0371378 A1
(43) Pub. Date: Nov. 19, 2026

(54) OBJECT STREAMING APPLICATION CLIENT-SIDE FETCHING ALGORITHM PARAMETER INDICATION

(71) Applicant: QUALCOMM Incorporated, San Diego, CA (US)

(72) Inventors: Saadallah KASSIR, San Diego, CA (US); Diana MAAMARI, San Diego, CA (US); Yih-Hao LIN, San Diego, CA (US); Mickaël MONDET, Louannec (FR); Peerapol TINNAKORNSRISUPHAP, San Diego, CA (US)

(21) Appl. No.: 19/212,473

(22) Filed: May 19, 2025

(51) Int. Cl. H04W 72/543; H04L 69/22; H04W 72/21

(52) U.S. Cl. CPC H04W 72/543; H04L 69/22; H04W 72/21

(57) ABSTRACT

This disclosure provides methods, components, devices and systems for object streaming application client-side fetching algorithm parameter indication. For example, wireless communications systems may support extended reality (XR) devices (e.g., XR user equipments (UEs)). Some XR UEs may perform object-fetching from a server (e.g., via a wireless connection such as a 5G or 6G connection). In object fetching, the XR UE may request (e.g., may fetch) an object from a server, and the server may respond with information regarding the desired object, which the streaming application at the XR device may locally render. In some aspects, an XR UE may provide timing type information to the network entity, where such timing type information is associated with a client-side object fetching algorithm for client-side rendering. The network entity may use the provided timing type information for scheduling of communications and/or to adjust communications parameters.

### TECHNICAL FIELD

This disclosure relates generally to wireless communication, and more specifically to systems, devices, methods, and techniques associated with object streaming application client-side fetching algorithm parameter indication.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communications by a UE is described. The method may include receiving, from a network entity, a first message that indicates one or more objects available to be fetched from the network entity in accordance with a client-side fetching algorithm at the UE and used in accordance with an object streaming application at the UE, transmitting, to the network entity, a second message that indicates one or more parameters associated with the client-side fetching algorithm, where the one or more parameters are associated with a timing or a size of a request to fetch an object of the one or more objects, and transmitting, to the network entity, the request to fetch the object in accordance with the client-side fetching algorithm.

A UE for wireless communications is described. The UE may include a processing system that includes processor circuitry and memory circuitry that stores code. The processing system may be configured to cause the UE to receive, from a network entity, a first message that indicates one or more objects available to be fetched from the network entity in accordance with a client-side fetching algorithm at the UE and used in accordance with an object streaming application at the UE, transmit, to the network entity, a second message that indicates one or more parameters associated with the client-side fetching algorithm, where the one or more parameters are associated with a timing or a size of a request to fetch an object of the one or more objects, and transmit, to the network entity, the request to fetch the object in accordance with the client-side fetching algorithm.

Another UE for wireless communications is described. The UE may include means for receiving, from a network entity, a first message that indicates one or more objects available to be fetched from the network entity in accordance with a client-side fetching algorithm at the UE and used in accordance with an object streaming application at the UE, means for transmitting, to the network entity, a second message that indicates one or more parameters associated with the client-side fetching algorithm, where the one or more parameters are associated with a timing or a size of a request to fetch an object of the one or more objects, and means for transmitting, to the network entity, the request to fetch the object in accordance with the client-side fetching algorithm.

A non-transitory computer-readable medium storing code for wireless communications is described. The code may include instructions executable by one or more processors to receive, from a network entity, a first message that indicates one or more objects available to be fetched from the network entity in accordance with a client-side fetching algorithm at the UE and used in accordance with an object streaming application at the UE, transmit, to the network entity, a second message that indicates one or more parameters associated with the client-side fetching algorithm, where the one or more parameters are associated with a timing or a size of a request to fetch an object of the one or more objects, and transmit, to the network entity, the request to fetch the object in accordance with the client-side fetching algorithm.

In some examples of the method, UEs, and non-transitory computer-readable medium described herein, the one or more parameters include a round trip time (RTT) associated with the request and a response to the request, a size of the request, a size of the response to the request, a duration between the request and a subsequent request, or any combination thereof.

Some examples of the method, UEs, and non-transitory computer-readable medium described herein may further include operations, features, means, or instructions for receiving, from the network entity and in response to the second message, control signaling that indicates one or more communication parameters.

In some examples of the method, UEs, and non-transitory computer-readable medium described herein, the one or more communication parameters include a discontinuous reception (DRX) pattern for the UE, uplink scheduling information, a recommended bit rate (RBR), or a combination thereof.

Some examples of the method, UEs, and non-transitory computer-readable medium described herein may further include operations, features, means, or instructions for transmitting the request via an available resource, where the one or more communication parameters indicates the available resource for the request.

Some examples of the method, UEs, and non-transitory computer-readable medium described herein may further include operations, features, means, or instructions for transmitting, to the network entity, a third message that indicates updated timing information associated with the client-side fetching algorithm based on the one or more communication parameters indicating a RBR.

A method for wireless communications by a network entity is described. The method may include outputting, for a UE, a first message that indicates one or more objects available to be fetched from the network entity in accordance with a client-side fetching algorithm at the UE and to be used in accordance with an object streaming application at the UE, obtaining, in association with the UE, a second message that indicates one or more parameters associated with the client-side fetching algorithm, where the one or more parameters are associated with a timing or a size of a request to fetch an object of the one or more objects, and obtaining, in association with the UE, the request to fetch the object in accordance with the client-side fetching algorithm.

A network entity for wireless communications is described. The network entity may include a processing system that includes processor circuitry and memory circuitry that stores code. The processing system may be configured to cause the network entity to output, for a UE, a first message that indicates one or more objects available to be fetched from the network entity in accordance with a client-side fetching algorithm at the UE and to be used in accordance with an object streaming application at the UE, obtain, in association with the UE, a second message that indicates one or more parameters associated with the client-side fetching algorithm, where the one or more parameters are associated with a timing or a size of a request to fetch an object of the one or more objects, and obtain, in association with the UE, the request to fetch the object in accordance with the client-side fetching algorithm.

Another network entity for wireless communications is described. The network entity may include means for outputting, for a UE, a first message that indicates one or more objects available to be fetched from the network entity in accordance with a client-side fetching algorithm at the UE and to be used in accordance with an object streaming application at the UE, means for obtaining, in association with the UE, a second message that indicates one or more parameters associated with the client-side fetching algorithm, where the one or more parameters are associated with a timing or a size of a request to fetch an object of the one or more objects, and means for obtaining, in association with the UE, the request to fetch the object in accordance with the client-side fetching algorithm.

A non-transitory computer-readable medium storing code for wireless communications is described. The code may include instructions executable by one or more processors to output, for a UE, a first message that indicates one or more objects available to be fetched from the network entity in accordance with a client-side fetching algorithm at the UE and to be used in accordance with an object streaming application at the UE, obtain, in association with the UE, a second message that indicates one or more parameters associated with the client-side fetching algorithm, where the one or more parameters are associated with a timing or a size of a request to fetch an object of the one or more objects, and obtain, in association with the UE, the request to fetch the object in accordance with the client-side fetching algorithm.

In some examples of the method, network entities, and non-transitory computer-readable medium described herein, the one or more parameters include an RTT associated with the request and a response to the request, a size of the request, a size of the response to the request, a duration between the request and a subsequent request, or any combination thereof.

Some examples of the method, network entities, and non-transitory computer-readable medium described herein may further include operations, features, means, or instructions for outputting, for the UE and in response to the second message, control signaling that indicates one or more communication parameters.

In some examples of the method, network entities, and non-transitory computer-readable medium described herein, the one or more communication parameters include a DRX pattern for the UE, uplink scheduling information, a RBR, or a combination thereof.

Some examples of the method, network entities, and non-transitory computer-readable medium described herein may further include operations, features, means, or instructions for obtaining the request via an available resource, where the one or more communication parameters indicates the available resource for the request.

Some examples of the method, network entities, and non-transitory computer-readable medium described herein may further include operations, features, means, or instructions for obtaining, in association with the UE, a third message that indicates updated timing information associated with the client-side fetching algorithm based on the one or more communication parameters indicating a RBR.

### BRIEF DESCRIPTION OF THE DRAWINGS

FIG. 1 shows an example of a wireless communication system.

FIG. 2 shows an example of a process flow that supports object streaming application client-side fetching algorithm parameter indication.

FIG. 3 shows an example of a signaling timing diagram that supports object streaming application client-side fetching algorithm parameter indication.

FIG. 4 shows an example of a signaling configuration that supports object streaming application client-side fetching algorithm parameter indication.

FIG. 5 shows an example of a signaling timing diagram that supports object streaming application client-side fetching algorithm parameter indication.

FIG. 6 shows an example of a signaling timing diagram that supports object streaming application client-side fetching algorithm parameter indication.

FIG. 7 shows an example of a signaling timing diagram that supports object streaming application client-side fetching algorithm parameter indication.

FIG. 8 shows an example of a signaling timing diagram that supports object streaming application client-side fetching algorithm parameter indication.

FIG. 9 shows an example of a process flow that supports object streaming application client-side fetching algorithm parameter indication.

FIG. 10 shows a block diagram of a processing system that supports object streaming application client-side fetching algorithm parameter indication.

FIG. 11 shows a diagram of a system including a device that supports object streaming application client-side fetching algorithm parameter indication.

FIG. 12 shows a block diagram of a processing system that supports object streaming application client-side fetching algorithm parameter indication.

FIG. 13 shows a diagram of a system including a device that supports object streaming application client-side fetching algorithm parameter indication.

FIGS. 14 and 15 show flowcharts illustrating methods that support object streaming application client-side fetching algorithm parameter indication.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

Some wireless communication systems, such as fifth generation (5G) and/or sixth generation (6G) communications may provide high-speed, low-latency, and high-reliability wireless connections and may support extended reality (XR) devices and cloud computing services (e.g., cloud based gaming). XR data may include virtual reality (VR) data, augmented reality (AR) data, mixed reality (MR) data, and other types of data which may be associated with high reliability and low latency transmissions. An XR device may also be referred to as an XR user equipment (UE). An XR UE may implement object rendering applications, which may render objects over a field of view (FOV) of a user. Some XR UEs may perform object-fetching from a server (e.g., via a wireless connection such as a 5G or 6G connection). In object fetching, the XR UE may request (e.g., may fetch) an object (e.g., a file) from a server, and the server may respond with information regarding the desired object, which the streaming application at the XR device may locally render. Object fetching may involve less data transmitted over the air as compared to pixel streaming, in which a server streams video frames back and forth with the XR UE. In object fetching, however, the timing requests for objects and corresponding responses may not be periodic and/or may not be known to the server and/or the network entity.

Aspects of the subject matter described in this disclosure relate to the provision of timing type information to the network entity, where such timing type information is associated with a client-side (e.g., at the XR UE) object fetching algorithm for client-side rendering. For example, the XR UE may indicate round trip time (RTT) information for object fetching requests and associated responses, timing information with respect to an expected next or next set of object fetching requests, and/or size information associated with a next request or response (which may affect the timing of the request and/or response). For example, the client-side object rendering application may determine the RTT based on previous requests and responses or based on size information associated with requested objects and current channel conditions. An object streaming application may be an application that requests/fetches files/objects from a remote server/network entity based on a fetching algorithm and receives a file/object in response to the request. For example, the object streaming application may used at a UE for use cases such as XR object-streaming, hyper text transfer protocol (HTTP) traffic, and/or DASH-based video streaming. As another example, the client-side object rendering application may determine request or response size based on an index provided from the server which may provide metadata associated with objects (e.g., files) available to be fetched. In some examples, the timing type information may be provided via headers or medium access control (MAC) control elements (MAC-CEs) within a request to fetch an object. In some examples, the XR UE may provide the timing type information via uplink assistance information (UAI). UAI may also be referred to as UE assistance information.

Particular aspects of the subject matter described in this disclosure can be implemented to realize one or more of the following potential advantages. In some examples, by providing timing type information associated with the client-side, the described techniques can be used by the network for scheduling of communications associated with the XR communications. For example, the network entity may use the provided timing type information for scheduling of communications and/or to adjust communications parameters. For example, the network entity may schedule uplink resources for the XR UE for requests based on the timing information. As another example, the network may indicate a discontinuous reception (DRX) cycle for the XR UE based on the timing information (e.g., based on estimated timings for responses). As another example, the network entity may update recommended bit rates (RBRs) for requests and responses based on the size information. By including the timing type information in a header or MAC-CE of a request, the timing type information may be conveyed along with a request to fetch an object and may not demand separate or additional signaling.

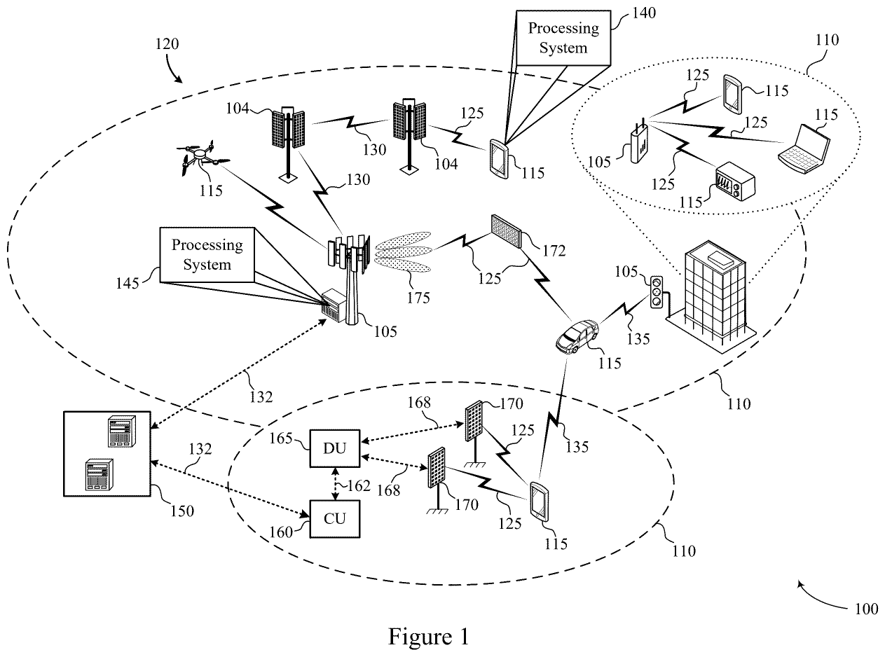

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A MAC layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or other adjustments to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

In some examples, low-latency and high-reliability wireless connectivity (e.g., URLLC) may enable support for latency-sensitive services such as XR applications. XR applications may include VR, AR, mixed reality (MR), or any combination thereof. In some examples, XR applications may include a group of UEs (e.g., XR devices such as VR/AR glasses, a VR Head-Mounted Display (HMD), VR gloves, or other similar devices) communicating data via a D2D communication link 135. Some other examples of latency-sensitive services may include holographic communications and MR communications. Holographic communications may refer to utilizing three dimensional (3D) images and video such that wireless devices (e.g., UEs 115) are capable of communicating and displaying holographic images (e.g., 3D images formed by an interference of light beams). MR communications may refer to a form of communications that includes VR, AR, or both, where users of a wireless device (e.g., a UE 115) can interact with visual elements displayed on the wireless device or via the wireless device. In some implementations, XR devices (e.g., UEs 115) may support metaverse applications that provide a virtual immersive environment to UEs 115 and users associated with the UEs 115. In some examples, metaverse applications may implement MR capabilities, holograms, or a combination thereof. Additionally, or alternatively, XR devices may support gesture monitoring, which may involve monitoring for motion or gestures (e.g., hand gestures) from a user to perform actions.

Devices of the wireless communication system 100 may be configured to support one or more aspects of the described techniques for object streaming application client-side fetching algorithm parameter indication. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the wireless communication system 100 (such as the RAN 120) may support provision of timing type information by an XR UE 115 to the serving network entity 105, where such timing type information is associated with a client-side (e.g., at the XR UE 115) object fetching algorithm for client-side rendering. For example, the XR UE 115 may indicate RTT information for object fetching requests and associated responses, timing information with respect to an expected next or next set of object fetching requests, and/or size information associated with a next request or response (which may affect the timing of the request and/or response). The network entity 105 may use the provided timing type information for scheduling of XR communications and/or to adjust communications parameters for the object fetching. For example, the network entity 105 may schedule uplink resources for the XR UE 115 for requests based on the timing information. As another example, the network entity 105 may indicate a DRX cycle for the XR device based on the timing information (e.g., based on estimated timings for responses). As another example, the network may update RBRs for requests and responses based on the size information.

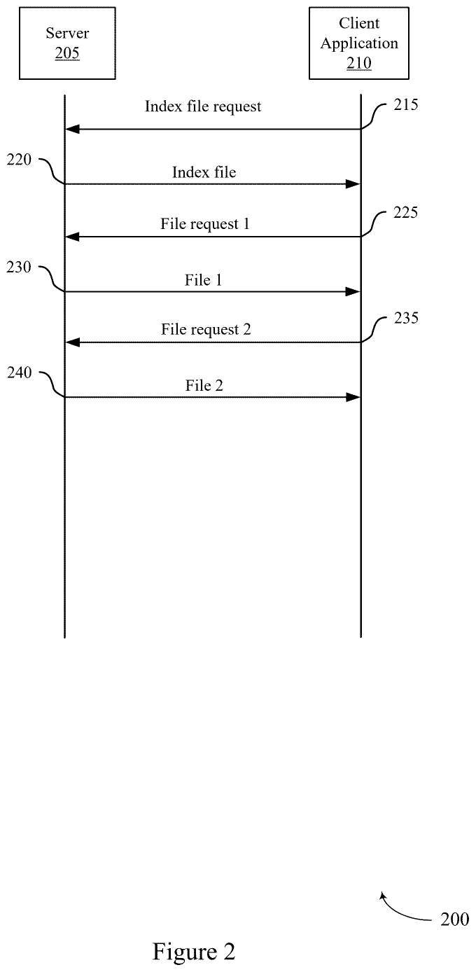

FIG. 2 shows an example of a process flow 200 that supports object streaming application client-side fetching algorithm parameter indication. The process flow 200 may implement or may be implemented by aspects of the wireless communication system 100. The process flow 200 may include a server 205 and a client application 210. For example, the client application 210 may be an XR client application that executes at an XR UE 115 as described herein (e.g., which provides an XR display to a user of the XR UE 115). The server 205 may be one or more computing nodes (e.g., an application executing at a cloud computing system) that may provide objects for presentation at the XR UE 115. For example, the XR UE may communicate with a network entity 105 that communicates with the server 205 via an internet connection such as a backhaul link 132 as described herein.

In the following description of the process flow 200, the operations between the client application 210 and the server 205 may be performed in different orders or at different times. Some operations may also be left out of the process flow 200, or other operations may be added. Although the client application 210 and the server 205 are shown performing the operations of the process flow 200, some aspects of some operations may also be performed by one or more other wireless devices.

As described herein, XR applications may have strict quality of service (QoS) demands, which may low latency, high reliability, high bandwidth, and/or low device power consumption. For example, XR devices that execute XR client applications, such as XR headsets, may have a small form factor and thus may have limited battery capability. Two types of XR applications may be implemented, pixel streaming and object streaming. Pixel streaming may include rendering on a remote server (e.g., the server 205) and streaming video (e.g., over a communication link 125 as described with reference to FIG. 1) back to the XR UE for display via the client application 210. Pixel streaming may provide high quality rendering but may be expensive to deploy and may be latency sensitive at the video frame level. Object streaming may involve rendering locally by the client application 210 at the XR UE 115 based on objects fetched from the server 205 (e.g., which may be a stateless HTTP webserver). For example, the client application 210 may only fetch objects (e.g., files) from the server that are relevant for a given FOV, and the client application 210 may determine the level of detail (LOD) to be downloaded (e.g., high LOD provides higher graphics but larger file sizes and thus may take longer to download). Object streaming may be less expensive to deploy and more scalable to deploy than pixel streaming, but may rely on device hardware (e.g., at the XR UE 115) for rendering and may be latency sensitive at the object level.

As shown in the process flow 200, to execute an object streaming application, at 215 the client application 210 may send an index file request. At 220, the server may provide the requested index file in response to the request at 215. For example, the index file may provide a list of available objects (e.g., files) the server 205 may provide and metadata about the objects. The metadata may indicate, for example, types of the available objects, data sizes of the available object, and/or other scene metadata (such as 3D coordinates or area information). For example, an object may be an image the client application may render in an FOV of the user on a display of the XR UE. In some examples, the index file request at 215 may be transmitted as an HTTP request, and the response at 220 may be an HTTP response. For example, HTTP requests and responses may be sent over transmission control protocol (TCP).

A fetching algorithm at the client application 210 may determine an object to fetch. At 225, the client application 210 may send a file request that indicates a requested object/file that was listed in the index file. For example, the client application 210 may determine the object to request based on the FOV or a change in the FOV (e.g., based on a new pose). At 230, the server 205 may provide the requested object in response to the request at 225. In some examples, the object/file request at 225 may be transmitted as an HTTP request, and the response at 230 may be an HTTP response. The client application may render a new scene with the retrieved first object at the XR UE (e.g., at the headset of the XR UE 115).

The fetching algorithm at the client application 210 may determine a next object to fetch (e.g., based on a change in the FOV or based on user interaction with the environment or the currently rendered and displayed objects). At 235, the client application 210 may send a second file request that indicates a second requested object/file that was listed in the index file. At 240, the server 205 may provide the requested object in response to the request at 235. In some examples, the object/file request at 235 may be transmitted as an HTTP request, and the response at 240 may be an HTTP response. The client application 210 may render a new scene with the retrieved second object at the XR UE (e.g., at the headset of the XR UE 115).

The response time between an object/file request and a corresponding response (e.g., the time between the request at 225 and the response at 230, the time between the request at 235 and the response at 240) may be a function of the file size of the requested object, the channel capacity, and the RTT. The fetching algorithm may be executed by different entities (e.g., a client application, a web browser, a web proxy), which entities may be referred to generically as a client application.

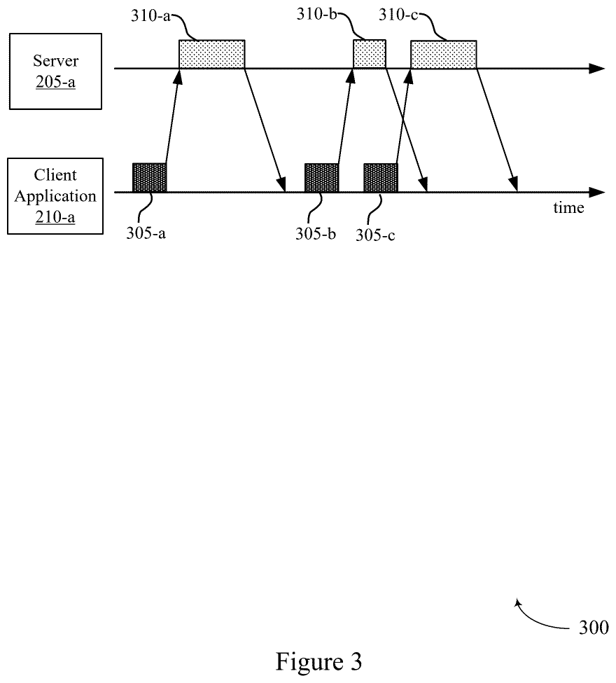

FIG. 3 shows an example of a signaling timing diagram 300 that supports object streaming application client-side fetching algorithm parameter indication. The signaling timing diagram 300 may implement or may be implemented by aspects of the wireless communication system 100 or the process flow 200. For example, the timing diagram illustrates timing of communications between a server 205-a, which may be an example of a server 205 as described herein, and a client application 210-a, which may be an example of a client application 210 as described herein.

As described herein, in XR object streaming applications, the client application 210-a may transmit HTTP requests 305 for particular files/objects, and the server 205-a may transmit HTTP responses 310 in response to the HTTP requests with the requested files/objects. For example, the client application 210-a may send a first HTTP request 305-a for a first object, and the server may provide a first HTTP response 310-a with the requested first object, which the client application 210-a may render and display at the XR UE 115. The client application 210-a may send a second HTTP request 305-b for a second object, and the server may provide a second HTTP response 310-b with the requested second object, which the client application 210-a may render and display at the XR UE 115. The client application 210-a may send a third HTTP request 305-c for a second object, and the server may provide a third HTTP response 310-c with the requested third object, which the client application 210-a may render and display at the XR UE 115. As the HTTP requests 305 may be based on a change in the FOV or based on user interaction with the environment or rendered and displayed object(s), the HTTP requests 305 not be periodic (e.g., may be on-demand). The HTTP requests 305 may each have a similar size (e.g., may indicate a requested object or file, for example via indication of a requested index number from the index file that corresponds to the requested object or file). HTTP responses 310 may similarly not be periodic, as HTTP responses 310 are responsive to corresponding HTTP requests 305 that are non-periodic (e.g., timing may be correlated to the HTTP requests 305). The HTTP responses 310 may each have different sizes, depending on the data size of the requested object.

In pixel streaming, video frames provided from a server 205 to the client application 210 may be provided periodically (in some cases with jitter), and the video frames may be based on pose packets sent periodically (in some cases with jitter) to the server 205 from the client application 210. The timing of the video frames, however, may not be correlated with the timing of the pose packets. The pose packets in pixel streaming applications may have similar data sizes, and the video frames may each have similar sizes.

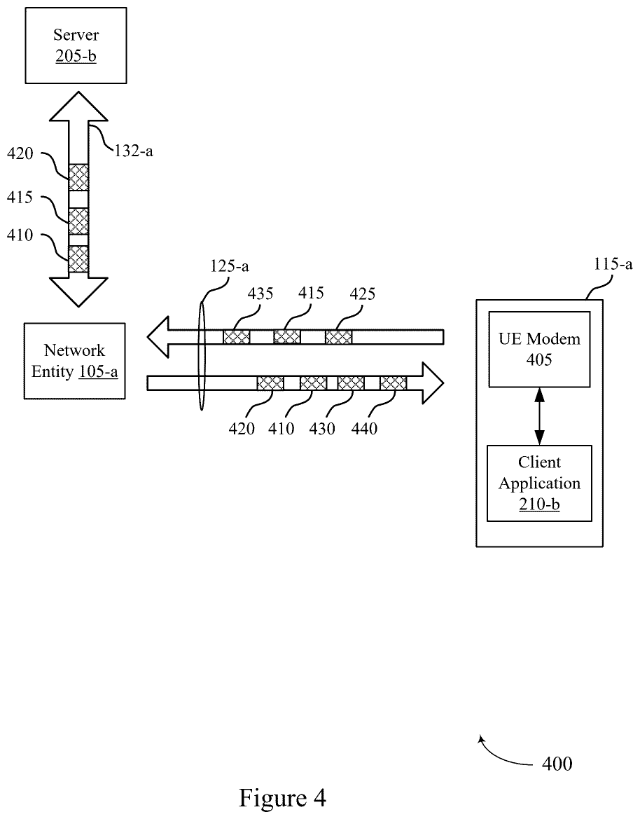

FIG. 4 shows an example of a signaling configuration 400 that supports object streaming application client-side fetching algorithm parameter indication. The signaling configuration 400 may implement or may be implemented by aspects of the wireless communication system 100, the process flow 200, or the signaling timing diagram 300. For example, the signaling configuration 400 may include a UE 115-a, which may be an example of a UE 115 as described herein. For example, the UE 115-a may be an XR device such as an XR headset that may execute a client application 210-b (e.g., which may be an example of a client application 210 as described herein). The signaling configuration 400 may include a network entity 105-a, which may be an example of a network entity 105 as described herein. The UE 115-a may include a modem 405 (e.g., communication circuitry) that may communicate with the network entity.

For example, the UE 115-a (e.g., the modem 405 of the UE 115-a) may communicate with the network entity 105-a using a communication link 125-a. The communication link 125-a may be an example of an NR or LTE link between the UE 115-a and the network entity 105-a. The communication link 125-a may include a bi-directional link that enables both uplink and downlink communications. For example, the UE 115-a may transmit uplink signals (e.g., uplink transmissions), such as uplink control signals or uplink data signals, to the network entity 105-a using the communication link 125-a and the network entity 105-a may transmit downlink signals (e.g., downlink transmissions), such as downlink control signals or downlink data signals, to the UE 115-a using the communication link 125-a.

The signaling configuration 400 may include a server 205-b, which may be an example of a server 205 as described herein. For example, the server 205-b may be a cloud server or an HTTP stateless server as described herein. The network entity 105-a may communicate with the server 205-b via a backhaul communication link 132-a (e.g., the network entity 105-a may communicate with the server 205-b via the core network 150 and via internet protocol (IP) services as described herein).

The client application 210-b may communicate data in the form of packet data units (PDUs) with the server 205-b. For example, to send a PDU to the server 205-b, the client application 210-b may send the PDU to the modem 405, which may transmit the PDU as an uplink message (e.g., via a physical uplink shared channel (PUSCH)) via the communication link 125-a to the network entity 105-a, which the network entity 105-a may route to the server 205-b via the backhaul communication link 132-a. As another example, to send a PDU to the client application 210-b, the server 205-b may send the PDU to the network entity 105-a via the backhaul communication link 132-a, the network entity 105-a may route the PDU to the UE 115-a via the communication link 125-a, and the modem 405 may receive the PDU and provide the PDU to the client application 210-b.

A PDU set may refer to one or more PDUs carrying a payload of one unit of information generated at the application level (e.g., generated by the client application 210-b). For example, a PDU set may carry frames for video or video slices. The PDUs of a PDU set may be transmitted within the same QoS flow. QoS flow mapping may use PDU set information or a QoS parameter. PDU set QoS parameters may be sent by an 5G session manager function (SMF) to the network entity 105-a to establish a QoS flow. The QoS parameters for a PDU set may include the PDU set error rate (PSER), the PDU set delay budget (PSDB) and the PS integrated handling indication (PSIHI). The PSER may indicate a maximum rate for non-congestion related packet losses. The PSDB may indicate a maximum time between reception of a first PDU and delivery of a last arrived PDU of a PDU set. The PSIHI may indicate whether all PDUs of a PDU set are demanded for usage of the PDU set by the application layer. The PDU set information may be provided to the network entity in a general packet radio service tunnelling protocol (GTP-U) header for downlink PDU set handling. For example, the PDU set information may include: 1) PDU set sequence number; 2) end PDU of the PDU set; 3) PDU sequence number within a PDU set; 4) PDU set size in bytes; and/or 5) PDU set importance information.

For object streaming XR applications, latency and user interface experience may be improved if the network entity 105-a is provided information regarding future traffic. In some examples, the network entity 105-a may provide information regarding future traffic or communication parameters to the client application 210-b, allowing the client application 210-b to use such information when sending object requests. Unlike pixel streaming XR applications, object streaming XR applications may have non-periodic and inconsistent file size traffic patterns, as described herein. The client-side fetching algorithm (e.g., executed by the client application 210-b at the UE 115-a) may provide information to the network entity 105-a, such as RTT measurement or prediction information (which may predict the HTTP response time after an HTTP request is sent), inter-request delay (which may indicate an expected time before the client application 210-a sends a next request—or may indicate the timing of multiple requests ahead), or expected HTTP request/response sizes. The network entity 105-a may use such information about expected upcoming requests: to improve scheduling policy (e.g., to pre-reserve downlink resources for responses); to improve the RBR for the UE 115-a to use for uplink communications on the communication link 125-a; to improve the RBR for other UEs 115; and/or to wake the UE 115-a preemptively to monitor for a physical downlink control channel (PDCCH) when downlink data is available. The UE 115-a may use signaling from the network entity 105-a that indicates timing information to: align HTTP request times to available resources for the network entity 105-a; or to improve XR object fetching decisions by the client application 210-b using the recommended RBR information.

For example, as described herein, the server 205-b may provide a first message 410, which the network entity 105-a may route to the UE 115-a. The first message 410 may indicate one or more objects (e.g., files) available to be fetched from the server 205-b. The UE 115-a may send one or more requests 415 to the server 205-b (e.g., via the network entity 105-a) to fetch respective objects (e.g., files) of the one or more available objects (e.g., files), and the server may provide one or more responses 420 corresponding to the one or more requests. In some examples, the UE 115-a may provide first signaling 425 (e.g., one or more control messages) to the network entity 105-a that indicates one or more parameters associated with the client side-fetching algorithm (e.g., associated with timing or a size of at least one of the one or more requests 415 or corresponding responses 420). The network entity 105-a may use such information for scheduling and/or setting communication parameters (e.g., RBRs). In some examples, the network entity 105-a may provide second signaling 430 (e.g., one or more control messages) to the UE 115-a associated with the client-side fetching. For example, the second signaling 430 may indicate to adapt HTTP request times for object streaming and/or that indicates congestion information for the network entity 105-a, recommended RBRs, and/or resource availability at the network entity 105-a. The UE 115-a (e.g., the client application 210-a) may use such information for scheduling and transmission of requests 415.

The client application 210-b may estimate, as part of an XR object fetching algorithm for object streaming, data such as the RTT, the inter-request time, a scheduled HTTP request, and/or the HTTP request or response size. For example, the RTT may be the time between sending by the client application 210-b (to the modem 405 for transmission) of a request 415 (e.g., an HTTP request to fetch an object) and reception by the client application 210-b (e.g., via the modem 405) of a first byte of a corresponding response 420 (e.g., a corresponding HTTP response). The inter-request time may indicate the time between two consecutive requests 415 (e.g., HTTP requests to fetch an object) or between subsequent batches of requests 415. The HTTP request/response file size in bytes may be based on the metadata (e.g., included in the first message 410) that indicates files sizes of different available objects and the specific requested objects in the requests 415. Based on the estimated data, the client application 210-b may estimate the next K request (e.g., HTTP request) arrival times for uplink transmission to the network entity 105-a and the corresponding response (e.g., HTTP response) times for downlink reception from the network entity 105-a. The UE 115-a may provide information based on such estimated data to the network entity 105-a in the first signaling 425. The network entity 105-a may use the information provided in the first signaling 425 to determine arrival times on uplink of requests 415 and on downlink for corresponding responses 420 (e.g., based on downlink queuing delay).

In some examples, the first signaling 425 may indicate to the network entity 105-a RTT information, scheduling information for requests 415 (e.g., inter-request timing information), and/or data sizes of requests 415 and/or responses 420 (e.g., if known to the client application 210-b and/or the modem 405). In some examples, the modem 405 may build and signal an anticipated object streaming (AOS) report, which may be sent via the first signaling 425 in a same transmission as a request 415. An AOS report may include: {RTT, inter-request schedule, and/or response size(s)}. In some examples, the AOS report (e.g., the first signaling 425) may be sent in a same transmission as a request 415 via adding one or more fields in a PDCP header of a previous uplink transmission (e.g., the corresponding HTTP request). In some examples, the AOS report (e.g., the first signaling 425) may be sent in a same transmission as a request 415 via a UAI (e.g., one or more fields may be added to a UAI report) that may be sent alongside each HTTP request and/or such a UAI may be sent periodically. In some examples, the AOS report (e.g., the first signaling 425) may be sent in a same transmission as a request 415 via one or more fields in a MAC-CE report that may be sent alongside each HTTP request and/or such a MAC-CE report may be sent periodically.

In some examples, an AOS report with 5 predicted objects may have the following structure: AOS report={File 1 Req. time, File 2 Req. time, File 3 Req. time, File 4 Req. time, File 5 Req. time; File 1 RTT, File 2 RTT, File 3 RTT, File 4 RTT, File 5 RTT; File 1 Size, File 2 Size, File 3 Size, File 4 Size, File 5 Size}.

In some examples, the UE 115-a may provide signaling 435 (e.g., via RRC signaling upon session initialization) that indicates preferred value ranges for the request time, the RTT, and/or the file size, which may allow the AOS report to be quantized and signaling via lower-layer protocols (e.g., via a MAC-CE). In some examples, the UE 115-a may provide (e.g., via the signaling 435) an indication of a preferred minimum and/or maximum value for each of the RTT, the inter-request time, and/or the file size fields. In some examples, the UE 115-a may provide (e.g., via the signaling 435) an indication of a preferred set of discrete values for each of the RTT, the inter-request time, and/or the file size fields. In some examples, the network entity 105-a may provide signaling 440 that may configure value ranges to build an AOS report. For example, the signaling 440 may use the preferred value ranges indicated by the UE 115-a in the signaling 435. In some examples, the network entity 105-a may provide (e.g., via the signaling 440) an indication of a minimum and/or maximum value for each of the RTT, the inter-request time, and/or the file size fields. For example, each entry of an AOS report may indicate a value between [0,1] (possibly quantized) such as into 1 or 2 bytes. In some examples, the network entity 105-a may provide (e.g., via the signaling 440) an indication of a set of discrete values for each of the RTT, the inter-request time, and/or the file size fields. For example, each entry of an AOS report may subsequently be an index corresponding to the closest value in the pre-signaled list (e.g., and the index may be encoded into 1 or 2 bytes).

The network entity 105-a may use information provided in the first signaling 425 (e.g., an AOS report) for scheduling and/or setting of communication parameters as described herein. For example, the network entity 105-a may adjust scheduling decisions and/or reduce queueing latency for an associated UE flow to reduce latency (e.g., such scheduling decisions may include pre-reservation of downlink resources, preemptive wake-up signal for PDCCH monitoring when data is expected to be received at the RAN, or preemptive uplink grants to save scheduling request (SR) or buffer status report (BSR) overhead, or any combination thereof). As another example, the network entity 105-a may adjust UE power saving feature(s) to reduce power at the UE 115-a and reduce latency. For example, the second signaling 430 may indicate updated DRX and/or sleep schedules for the UE 115-a based on the information in the first signaling 425. For example, the UE 115-a may be allowed to sleep for a longer period of time if no uplink or downlink traffic is expected for a known period. As another example, the network entity 105-a may adjust the RBR for the UE 115-a (e.g., and may indicate the adjusted RBR in the second signaling 430) to improve user experience at the UE 115-a. For example, the network entity 105-a may be aware of other traffic scheduled at the same time as requests 415 or responses 420 as indicated by the information in the first signaling 425, and the UE 115-a may use the new RBR to make scheduling decisions (e.g., when to send requests 415). In some examples, the network entity 105-a may use the information in the first signaling 425 to adjust the RBR for other UEs 115 (e.g., to improve user experience). For example, the network entity 105-a may be aware of the XR traffic of the UE 115-a based on the first signaling 425, and thus may bias traffic from other UEs 115 by adjusting respective RBRs for the other UEs 115 accordingly.

The UE 115-a may benefit from feedback provided from the network entity 105-a (e.g., in the second signaling 430). For example, the second signaling 430 may indicate timing of an uplink grant, which may enable the UE 115-a to adjust object fetching policies to align with the uplink grant timing. The client application 210-b and the object fetching algorithm may benefit from feedback from the network entity 105-a (e.g., via the second signaling 430) in at least two ways. First, the client application 210-b may align HTTP request generation and transmission time to the preferred transmission time provided by the network entity 105-a (e.g., as indicated in the second signaling 430), as the network entity 105-a may be aware of other traffic to be served on the uplink or downlink by the network entity 105-a. For example, the network entity 105-a may bias the traffic of the client application 210-b to reduce or minimize uplink and/or downlink queuing and scheduling delay. Second, the client application 210-b may use the RBR information provided by the network entity 105-a (e.g., via the second signaling 430) to improve the object fetching policy. For example, the client application 210-b may estimate fetching latency for an object as follows: latency=RTT+file_size/link_capacity. RTT may be estimated over the top (OTT) by the client application 210-b based on previous requests 415 and corresponding responses 420, and the file size may be known based on the requested object from the index file provided in the first message 410. The RBR may be used to determine the link capacity. For example, proper link capacity may be the one the file will observe after 1×RTT in the future. The network entity 105-a may use the AOS report to provide a link capacity prediction instead of the instantaneous value. A link capacity prediction may use information that the known to the network entity 105-a, such as traffic from other UEs 115 that may have been provided via AOS reports from the other UEs.

In some examples, the network entity 105-a may use the AOS report to indicate to the UE 115-a the earliest (or preferred) time the UE 115-a may be scheduled (e.g., provided an uplink resource) on the uplink. For example, if an AOS report indicates that client application 210-b expects to transmit a next HTTP request at time T1, and the network entity 105-a expect another UE 115 with uplink heavy traffic to transmit and use uplink resources from time T1 to T2, then the network entity 105-a may indicate to UE 115-a that the preferred time for uplink scheduling is T2 or later. As another example, the network entity 105-a may also use an AOS report to determine the corresponding arrival time of the next HTTP response, and may provide a preferred time to the UE 115-a to monitor for the response based on knowledge at the network entity 105-a of upcoming downlink traffic. In some examples, the second signaling 430 that indicates such preferred scheduling times (or time offsets) for uplink transmission or downlink monitoring may be indicated to the UE via a MAC-CE. The UE 115-a may forward such network entity preferred scheduling timing information to the client application 210-b (e.g., via a northbound cross-layer application programming interface (API). In some examples, the client application 210-b may determine to align an HTTP request to the preferred uplink scheduling time provided by the network entity 105-a. Provision of such information to the client application 210-b may enable the client application 210-b to generate the next request at a latest possible time, using the most recent information (e.g., viewport, scene content), as opposed to having the request age in the uplink buffer and risk becoming obsolete.

Provision of information in the first signaling 425 about more than one future request 415 and/or response 420 may enable the network entity 105-a to assist with scheduling policy over a longer time horizon than provision of information regarding a single future request 415. However, predicted estimates for parameters (e.g., RTT, inter-request time, request/response size) for future requests 415 and/or responses 420 may change over time. For example, the predicted estimates may change due to a change in the XR scene (e.g., new files/objects may be expected to be fetched instead of originally indicated objects/files). As another example, the predicted estimates may change due to delay in HTTP request transmission (e.g., due to information in the second signaling 430 from the network entity 105-a, which may impact future inter-request times). As another example, the predicted estimates may change due to changes in channel conditions (e.g., which may lead to different decisions taken by the client side object algorithm, a different RTT, and/or different transmission delays impacting inter-request time). Accordingly, in some examples, information in more recent AOS reports/first signaling 425 from the UE 115-a may have precedent over information in previous or older AOS reports/first signaling 425 from the UE 115-a. For example, while transmitting an HTTP request (e.g., a request 415), the client application 210-b may indicate the next five object inter-request times to be {50, 100, 75, 120, 60} milliseconds (ms). Then While transmitting the next HTTP request, the client application 210-b may indicate next five 5 object inter-request times to be {100, 90, 120, 60, 40} ms. Accordingly, the network entity 105-a may update the third inter-request size from 75 ms to 90 ms and may reallocate resources accordingly.

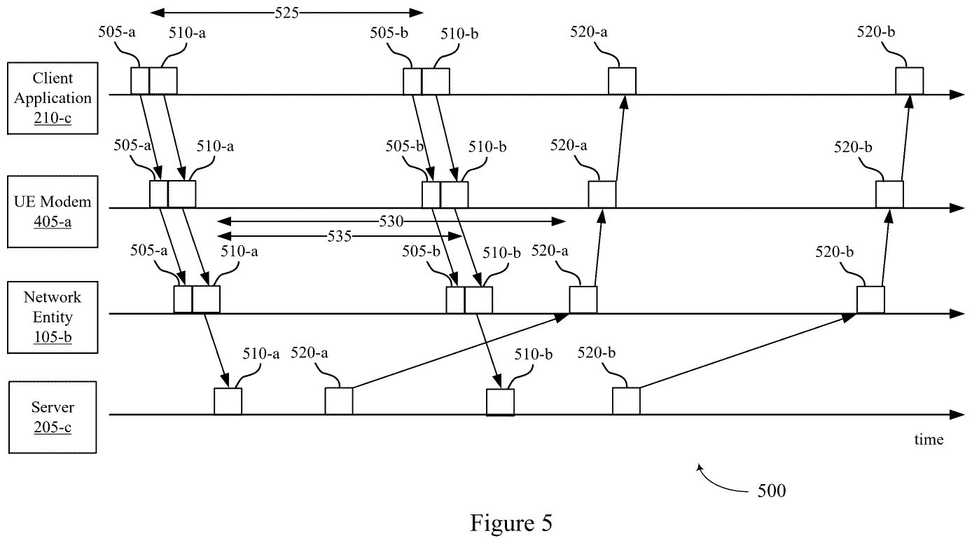

FIG. 5 shows an example of a signaling timing diagram 500 that supports object streaming application client-side fetching algorithm parameter indication. The signaling timing diagram 500 may implement or may be implemented by aspects of the wireless communication system 100, the process flow 200, the signaling timing diagram 300, or the signaling configuration 400. For example, the signaling timing diagram 500 may illustrate example timing of signaling between a client application 210-c, a UE modem 405-a, a network entity 105-b, and a server 205-c, which may be examples of corresponding devices as described herein.

The client application 210-c may send a request 510-a for an object (e.g., an HTTP request) on a southbound API to the UE modem 405-a. The client application 210-c may include a report 505-a (e.g., an AOS report or first signaling 425 as described herein) with the request 510-a. For example, the report 505-a may indicate parameters associated with the client-side object fetching algorithm at the client application 210-c such as an RTT estimate, an estimated inter-request time 535 (e.g., between the request 510-a and a next request for an object), and/or size information associated with the request 510-a or a corresponding response (that includes the requested object, where the size information may be based on an index file provided from the server that provides size data associated with available objects to be fetched). The UE modem 405-a may receive the request 510-a and the report 505-a and may transmit the request 510-a and the report 505-a (e.g., via an uplink transmission such as a PUSCH/PUCCH) to the network entity 105-b. The network entity 105-b may send the request 510-a to the server 205-c, and the network entity 105-b may decode the information in the report 505-a. The server 205-c may send a response 520-a that corresponds to the request 510-a (e.g., which includes the requested object) to the network entity 105-b, which the network entity 105-b may transmit to the UE modem 405-a (e.g., via a downlink transmission such as a PDSCH/PDCCH). The UE modem 405-a may send the response 520-a to the client application 210-c, and the client application 210-c may render and display the fetched object. A time between reception of the request 510-a at the network entity 105-b and reception of the response 520-a that corresponds to the request 510-a at the network entity 105-b may be referred to as a response delay 530.

In some examples, prior to receiving the response 520-a, the client application 210-c may send a request 510-b for a second object (e.g., a second HTTP request) on a southbound API to the UE modem 405-a. The time between the request 510-a and the request 510-b may be the actual inter-request time 525. The client application 210-c may include a report 505-b (e.g., an AOS report or first signaling 425 as described herein) with the request 510-b. For example, the report 505-b may indicate parameters associated with the client-side object fetching algorithm at the client application 210-c such as an RTT estimate, an estimated inter-request time (e.g., between the request 510-b and a next request for an object), and/or size information associated with the request 510-b or a corresponding response (that includes the requested second object, where the size information may be based on an index file provided from the server that provides size data associated with available objects to be fetched). The UE modem 405-a may receive the request 510-b and the report 505-b and may transmit the request 510-b and the report 505-b (e.g., via an uplink transmission such as a PUSCH/PUCCH) to the network entity 105-b. The network entity 105-b may send the request 510-b to the server 205-c, and the network entity 105-b may decode the information in the report 505-b. The server 205-c may send a response 520-b that corresponds to the request 510-b (e.g., which includes the requested second object) to the network entity 105-b, which the network entity 105-b may transmit to the UE modem 405-a (e.g., via a downlink transmission such as a PDSCH/PDCCH). The UE modem 405-a may send the response 520-b to the client application 210-c, and the client application 210-c may render and display the fetched second object.

The request 510-b on uplink (e.g., from the UE modem 405-a to the network entity 105-b) may experience reduced or minimal buffering delay because the network entity 105-b may pre-reserve uplink resources for the request 510-b based on inter-request information in the report 505-a. The response 520-b may experience reduced or minimal queuing/scheduling delay at downlink (e.g., from the network entity 105-b to the UE modem 405-b) due to the information (e.g., RTT information or estimated response delay information) included in the report 505-a. For example, the network entity 105-b may pre-reserve resources for the response 520-a based on the information in the report 505-a.

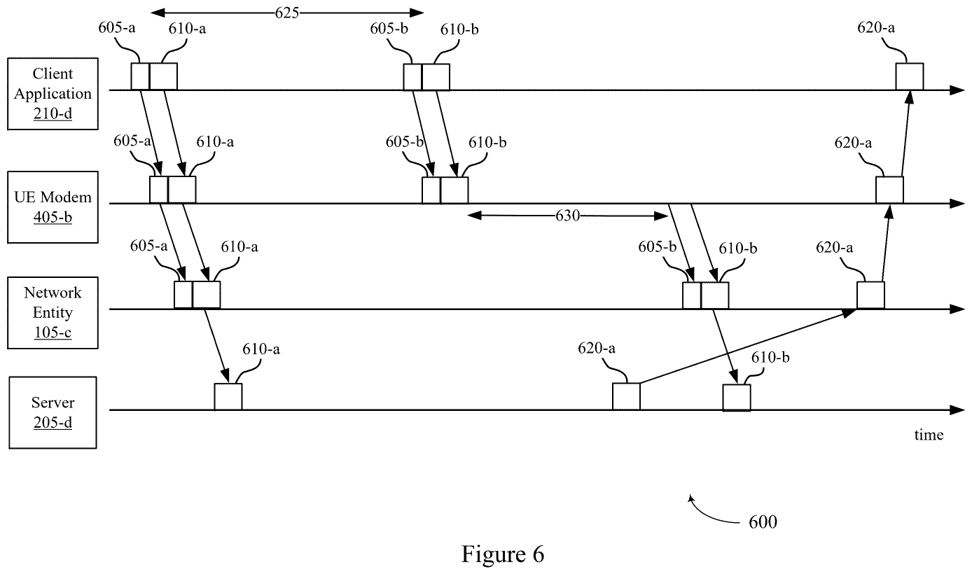

FIG. 6 shows an example of a signaling timing diagram 600 that supports object streaming application client-side fetching algorithm parameter indication. The signaling timing diagram 600 may implement or may be implemented by aspects of the wireless communication system 100, the process flow 200, the signaling timing diagram 300, or the signaling configuration 400. For example, the signaling timing diagram 600 may illustrate example timing of signaling between a client application 210-d, a UE modem 405-b, a network entity 105-c, and a server 205-d, which may be examples of corresponding devices as described herein.

The client application 210-d may send a request 610-a for an object (e.g., an HTTP request) on a southbound API to the UE modem 405-b. The client application 210-d may include a report 605-a (e.g., an AOS report or first signaling 425 as described herein) with the request 610-a. For example, the report 605-a may indicate parameters associated with the client-side object fetching algorithm at the client application 210-d such as an RTT estimate, an estimated inter-request time (e.g., between the request 610-a and a next request for an object), and/or size information associated with the request 610-a or a corresponding response (that includes the requested object, where the size information may be based on an index file provided from the server that provides size data associated with available objects to be fetched). The UE modem 405-b may receive the request 610-a and the report 605-a and may transmit the request 610-a and the report 605-a (e.g., via an uplink transmission such as a PUSCH/PUCCH) to the network entity 105-c. The network entity 105-c may send the request 610-a to the server 205-d, and the network entity 105-c may decode the information in the report 605-a. The server 205-d may send a response 620-a that corresponds to the request 610-a (e.g., which includes the requested object) to the network entity 105-c, which the network entity 105-c may transmit to the UE modem 405-b (e.g., via a downlink transmission such as a PDSCH/PDCCH). The UE modem 405-b may send the response 620-a to the client application 210-d, and the client application 210-d may render and display the fetched object.

In some examples, prior to receiving the response 620-a, the client application 210-d may send a request 610-b for a second object (e.g., a second HTTP request) on a southbound API to the UE modem 405-b. The time between the request 610-a and the request 610-b may be the actual inter-request time 625. The client application 210-d may include a report 605-b (e.g., an AOS report or first signaling 425 as described herein) with the request 610-b. For example, the report 605-b may indicate parameters associated with the client-side object fetching algorithm at the client application 210-d such as an RTT estimate, an estimated inter-request time (e.g., between the request 610-b and a next request for an object), and/or size information associated with the request 610-b or a corresponding response (that includes the requested second object, where the size information may be based on an index file provided from the server that provides size data associated with available objects to be fetched). The UE modem 405-b may receive the request 610-b and the report 605-b and may transmit the request 610-b and the report 605-b (e.g., via an uplink transmission such as a PUSCH/PUCCH) to the network entity 105-c. The request 610-b (and the report 605-b) may experience delay 630 at the UE modem 405-b (e.g., in a buffer at the UE) as the network entity 105-b schedules other UEs.

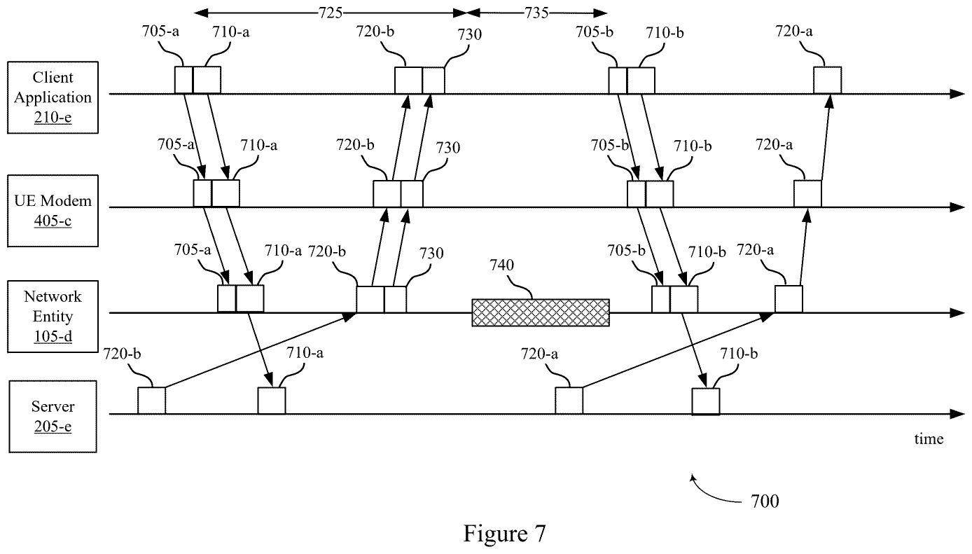

FIG. 7 shows an example of a signaling timing diagram 700 that supports object streaming application client-side fetching algorithm parameter indication. The signaling timing diagram 700 may implement or may be implemented by aspects of the wireless communication system 100, the process flow 200, the signaling timing diagram 300, or the signaling configuration 400. For example, the signaling timing diagram 700 may illustrate example timing of signaling between a client application 210-e, a UE modem 405-c, a network entity 105-d, and a server 205-e, which may be examples of corresponding devices as described herein.

The client application 210-e may send a request 710-a for an object (e.g., an HTTP request) on a southbound API to the UE modem 405-c. The client application 210-e may include a report 705-a (e.g., an AOS report or first signaling 425 as described herein) with the request 710-a. For example, the report 705-a may indicate parameters associated with the client-side object fetching algorithm at the client application 210-e such as an RTT estimate, an estimated inter-request time (e.g., between the request 710-a and a next request for an object), and/or size information associated with the request 710-a or a corresponding response (that includes the requested object, where the size information may be based on an index file provided from the server that provides size data associated with available objects to be fetched). The UE modem 405-c may receive the request 710-a and the report 705-a and may transmit the request 710-a and the report 705-a (e.g., via an uplink transmission such as a PUSCH/PUCCH) to the network entity 105-d. The network entity 105-d may send the request 710-a to the server 205-e, and the network entity 105-d may decode the information in the report 705-a. The server 205-e may send a response 720-a that corresponds to the request 710-a (e.g., which includes the requested object) to the network entity 105-d, which the network entity 105-d may transmit to the UE modem 405-c (e.g., via a downlink transmission such as a PDSCH/PDCCH). The UE modem 405-c may send the response 720-a to the client application 210-e, and the client application 210-e may render and display the fetched object.

In some examples, the client application 210-e may send a request 710-b for a second object (e.g., a second HTTP request) on a southbound API to the UE modem 405-c. The time between the request 710-a and the request 710-b may be the actual inter-request time. In some examples, control information 730 from the network entity 105-d may indicate for the client application 210-e to delay the time of the request 710-b from an original inter-request time 725 by an offset 735 (such that the total inter-request time between the request 710-a and the request 710-b is the original inter-request time 725 plus the offset 735). For example, the network entity 105-d may receive a response 720-b to a prior request from the client application 210-e. The network entity 105-d may transmit the response 720-b along with the control information 730 to the UE modem 405-c (e.g., via a downlink transmission such as a PDSCH/PDCCH). For example, the control information 730 may be included in a header or a MAC-CE of the PDU that includes the response 720-b. For example, the control information 730 may be second signaling 430 as described herein. The UE modem 405-c may send the response 720-b and the control information 730 to the client application 210-e (e.g., via a northbound API), and the client application 210-e may render and display the fetched object. The control information 730 may indicate a preferred time for a next request (e.g., may indicate to delay the request 710-b by the offset 735), for example, based on an experienced busy traffic period 740 at the network entity 105-d.

The client application 210-e may include a report 705-b (e.g., an AOS report or first signaling 425 as described herein) with the request 710-b. For example, the report 705-b may indicate parameters associated with the client-side object fetching algorithm at the client application 210-e such as an RTT estimate, an estimated inter-request time (e.g., between the request 710-b and a next request for an object), and/or size information associated with the request 710-b or a corresponding response (that includes the requested second object, where the size information may be based on an index file provided from the server that provides size data associated with available objects to be fetched). The UE modem 405-c may receive the request 710-b and the report 705-b and may transmit the request 710-b and the report 705-b (e.g., via an uplink transmission such as a PUSCH/PUCCH) to the network entity 105-d. The network entity 105-d may send the request 710-b to the server 205-e, and the network entity 105-d may decode the information in the report 705-b.

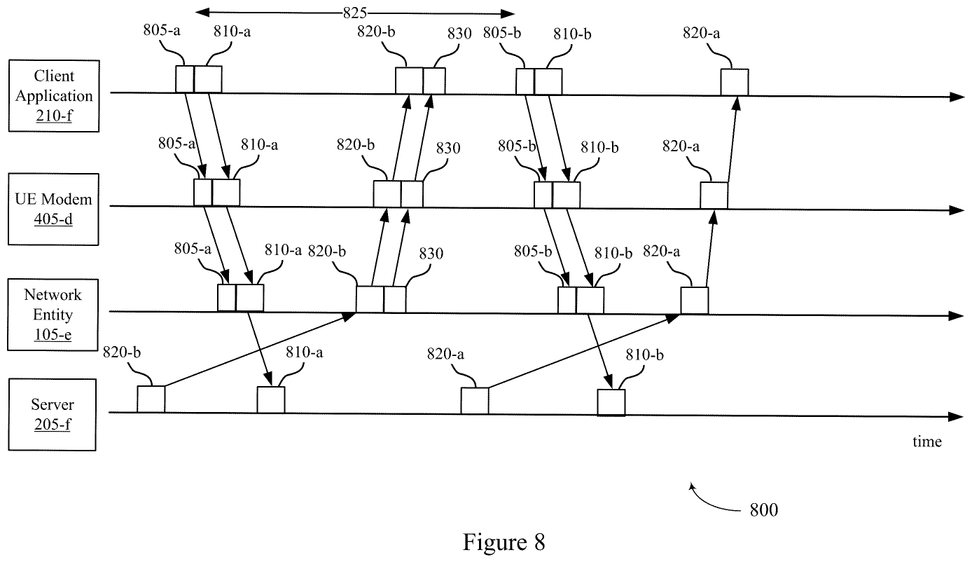

FIG. 8 shows an example of a signaling timing diagram 800 that supports object streaming application client-side fetching algorithm parameter indication. The signaling timing diagram 800 may implement or may be implemented by aspects of the wireless communication system 100, the process flow 200, the signaling timing diagram 300, or the signaling configuration 400. For example, the signaling timing diagram 800 may illustrate example timing of signaling between a client application 210-f, a UE modem 405-d a network entity 105-e, and a server 205-f, which may be examples of corresponding devices as described herein.

The client application 210-f may send a request 810-a for an object (e.g., an HTTP request) on a southbound API to the UE modem 405-d. The client application 210-f may include a report 805-a (e.g., an AOS report or first signaling 425 as described herein) with the request 810-a. For example, the report 805-a may indicate parameters associated with the client-side object fetching algorithm at the client application 210-f such as an RTT estimate, an estimated inter-request time (e.g., between the request 810-a and a next request for an object), and/or size information associated with the request 810-a or a corresponding response (that includes the requested object, where the size information may be based on an index file provided from the server that provides size data associated with available objects to be fetched). The UE modem 405-d may receive the request 810-a and the report 805-a and may transmit the request 810-a and the report 805-a (e.g., via an uplink transmission such as a PUSCH/PUCCH) to the network entity 105-e. The network entity 105-e may send the request 810-a to the server 205-f, and the network entity 105-e may decode the information in the report 805-a. The server 205-f may send a response 820-a that corresponds to the request 810-a (e.g., which includes the requested object) to the network entity 105-e, which the network entity 105-e may transmit to the UE modem 405-d (e.g., via a downlink transmission such as a PDSCH/PDCCH). The UE modem 405-d may send the response 820-a to the client application 210-f, and the client application 210-f may render and display the fetched object.

In some examples, the client application 210-f may send a request 810-b for a second object (e.g., a second HTTP request) on a southbound API to the UE modem 405-d. The time between the request 810-a and the request 810-b may be the actual inter-request time 825. In some examples, control information 830 from the network entity 105-e may indicate for the client application 210-f a timing for the request 810-b and/or an RBR for the request 810-b. For example, the network entity 105-e may receive a response 820-b to a prior request from the client application 210-f. The network entity 105-e may transmit the response 820-b along with the control information 830 to the UE modem 405-d (e.g., via a downlink transmission such as a PDSCH/PDCCH). For example, the control information 830 may be included in a header or a MAC-CE of the PDU that includes the response 820-b. For example, the control information 830 may be second signaling 430 as described herein. The UE modem 405-d may send the response 820-b and the control information 830 to the client application 210-f (e.g., via a northbound API), and the client application 210-f may render and display the fetched object. The control information 830 may indicate a preferred time and/or RBR for a next request (e.g., may indicate to delay the request 810-b and/or may indicate an RBR for the request based on new RBR data). The client application 210-f may accordingly use the recommended RBR and/or timing information in the control information 830 for scheduling the next request (e.g., the request 810-b). For example, the client application 210-f may adapt object fetching decisions and/or the timing of the request 810-b based on the control information 830 (e.g., based on the RBR and/or the timing information in the control information 830).

The client application 210-f may include a report 805-b (e.g., an AOS report or first signaling 425 as described herein) with the request 810-b. For example, the report 805-b may indicate parameters associated with the client-side object fetching algorithm at the client application 210-f such as an RTT estimate, an estimated inter-request time (e.g., between the request 810-b and a next request for an object), and/or size information associated with the request 810-b or a corresponding response (that includes the requested second object, where the size information may be based on an index file provided from the server that provides size data associated with available objects to be fetched). The UE modem 405-d may receive the request 810-b and the report 805-b and may transmit the request 810-b and the report 805-b (e.g., via an uplink transmission such as a PUSCH/PUCCH) to the network entity 105-e. The network entity 105-e may send the request 810-b to the server 205-f, and the network entity 105-e may decode the information in the report 805-b.

The response 820-a may experience reduced or minimal delay at the network entity 105-e (e.g., between reception at the network entity 105-e from the server 205-f and transmission to the UE modem 405-d) due to scheduling enhancements or optimizations based on the reports 805 and/or DRX alignment at the UE modem 405-d (and other UEs) as indicated in the control information 830. For example, the network entity 105-e may pre-allocate resources for the response 820-a based on the report 805-a and/or other reports from other UEs 115. In some examples, the network entity 105-e may align the UE DRX configuration with the downlink resource for the response 820-a based on information in the report 805-a and/or the information from other reports from other UEs 115. In some examples, the control information 830 may indicate the DRX configuration for the UE (e.g., the control information 830 may align the DRX pattern of the UE modem 405-d with the downlink resource for the response 820-a).

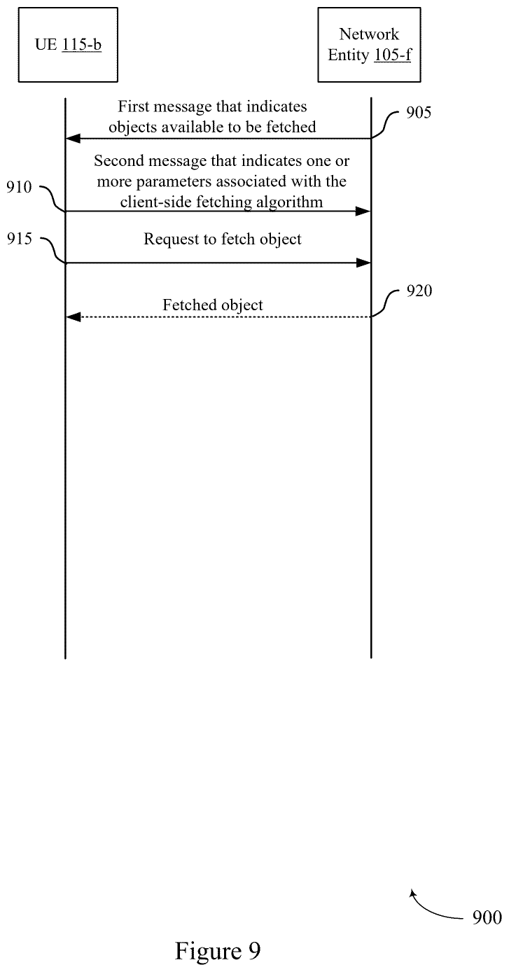

FIG. 9 shows an example of a process flow 900 that supports object streaming application client-side fetching algorithm parameter indication. The process flow 900 may implement or may be implemented by aspects of the wireless communication system 100, the process flow 200, the signaling timing diagram 300, or the signaling configuration 400. For example, the process flow 900 may include a UE 115-b and a network entity 105-f, which may be examples of corresponding devices as described herein. In the following description of the process flow 900, the operations between the UE 115-b and the network entity 105-f may be performed in different orders or at different times. Some operations may also be left out of the process flow 900, or other operations may be added. Although the UE 115-b and the network entity 105-f are shown performing the operations of the process flow 900, some aspects of some operations may also be performed by one or more other wireless devices.

At 905, the UE 115-b may receive, from the network entity 105-f, a first message that indicates one or more objects available to be fetched from the network entity 105-f in accordance with a client-side fetching algorithm at the UE 115-b and used in accordance with an object streaming application (e.g., a client application 210 as described herein) at the UE 115-b. For example, the UE 115-b may render the object in accordance with the object streaming application. As described herein, an object streaming application may be an application that requests/fetches files/objects from a remote server/network entity based on a fetching algorithm and receives a file/object in response to the request. For example, the object streaming application may used for use cases such as XR object-streaming, HTTP traffic, and/or DASH-based video streaming. For example, the network entity 105-f may retrieve the objects from a server 205 as described herein and may provide the objects to the UE 115-b. The first message may include an index file as described herein. In some examples, the first message may be responsive to an index file request sent from the UE 115-b to the network entity 105-f (which the network entity 105-f may route to the server).

At 910, the UE 115-b may transmit, to the network entity 105-f, a second message that indicates one or more parameters associated with the client-side fetching algorithm. The one or more parameters may be associated with a timing or a size of a request to fetch an object of the one or more objects.

At 915, the UE 115-b may transmit, to the network entity 105-f, the request to fetch the object in accordance with the client-side fetching algorithm. In some examples, the network entity 105-f may route the request to a server as described herein.

In some examples, at 920, the UE 115-b may receive, from the network entity 105-f and based on the request, a third message that includes the object in accordance with the client-side fetching algorithm. For example, the network entity 105-f may receive the object from the server and may route the object to the UE 115-b.

In some examples, the one or more parameters include an RTT associated with the request and a response to the request, a size of the request, a size of the response to the request, a duration between the request and a subsequent request (e.g., an inter-request time), or any combination thereof. In some examples, the UE 115-b may transmit the second message via a header of an uplink message that includes the request (e.g., where the request is included in a PDU and the header is a PDCP header of the PDU). In some examples, the UE 115-b may transmit a UAI message that includes the one or more parameters. In some examples, the UE 115-b may transmit the second message via a MAC-CE of an uplink message that includes the request. In some examples, the UE 115-b may transmit such parameter-type associated with the client-side fetching algorithm as included in the second message periodically.

In some examples, at least one parameter of the one or more parameters may include a range of values.

In some examples, at least one parameter of the one or more parameters may include a discrete value selected from a set of candidate discrete values. In some examples, the UE 115-b may receive, from the network entity 105-f, control signaling that configures the set of candidate discrete values associated with the at least one parameter.

In some examples, the UE 115-b may receive, from the network entity 105-f and in response to the second message, control signaling that indicates one or more communication parameters. In some examples, the one or more communication parameters may include a DRX pattern for the UE 115-b, uplink scheduling information, a RBR, or a combination thereof. In some examples, the UE 115-b may transmit the request via an available resource, and the one or more communication parameters may indicate the available resource for the request. In some examples, the UE 115-b may provide an indication of the available resource for the request to the object streaming application (e.g., to the client application), and the UE 115-b may obtain, from the object streaming application, an indication to transmit the request via the available resource.

In some examples, the UE 115-b may transmit, to the network entity 105-f, a third message that indicates updated timing information associated with the client-side fetching algorithm based on the one or more communication parameters indicating a RBR.

In some examples, the UE 115-b may transmit, to the network entity 105-f after transmission of the second message, a third message that indicates one or more updated parameters associated with the client-side fetching algorithm. The one or more parameters may be indicative of first timing or size information associated with a second request to fetch the object or a second object of the one or more objects, the second request may be after the request, and the one or more updated parameters may be indicative of updated timing or size information associated with the second request.

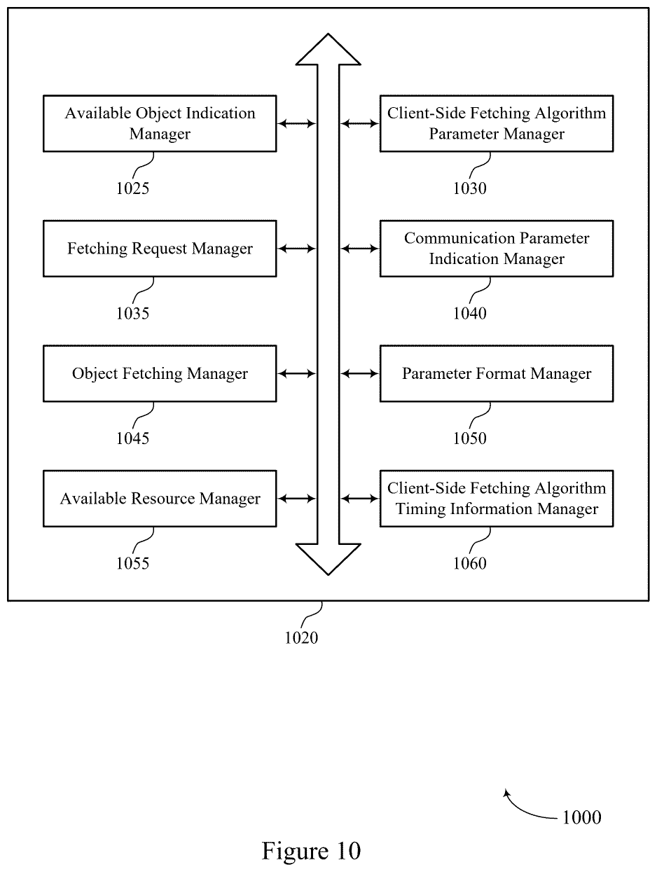

FIG. 10 shows an example 1000 of a processing system 1020 that supports object streaming application client-side fetching algorithm parameter indication. A processing system 1020 may be an example of a processing system 140 (such as of a UE 115) and may include an available object indication manager 1025, a client-side fetching algorithm parameter manager 1030, a fetching request manager 1035, a communication parameter indication manager 1040, an object fetching manager 1045, a parameter format manager 1050, an available resource manager 1055, a client-side fetching algorithm timing information manager 1060, or any combination thereof. A processing system 1020, or various component thereof, may be an example of means for performing (such as a means for causing a UE 115 to perform) various techniques described herein.

The available object indication manager 1025 may be configured to cause the UE 115 to receive, from a network entity, a first message that indicates one or more objects available to be fetched from the network entity in accordance with a client-side fetching algorithm at the UE and used in accordance with an object streaming application at the UE. The client-side fetching algorithm parameter manager 1030 may be configured to cause the UE 115 to transmit, to the network entity, a second message that indicates one or more parameters associated with the client-side fetching algorithm, where the one or more parameters are associated with a timing or a size of a request to fetch an object of the one or more objects. The fetching request manager 1035 may be configured to cause the UE 115 to transmit, to the network entity, the request to fetch the object in accordance with the client-side fetching algorithm.

In some examples, the one or more parameters include an RTT associated with the request and a response to the request, a size of the request, a size of the response to the request, a duration between the request and a subsequent request, or any combination thereof.

In some examples, to support transmitting the second message, the fetching request manager 1035 may be configured to cause the UE 115 to transmit the second message via a header of an uplink message that includes the request.

In some examples, to support transmitting the second message, the fetching request manager 1035 may be configured to cause the UE 115 to transmit a UAI message that includes the one or more parameters.

In some examples, to support transmitting the second message, the fetching request manager 1035 may be configured to cause the UE 115 to transmit the second message via a MAC-CE of an uplink message that includes the request.

In some examples, at least one parameter of the one or more parameters includes a range of values.

In some examples, at least one parameter of the one or more parameters includes a discrete value selected from a set of candidate discrete values.

In some examples, the parameter format manager 1050 may be configured to cause the UE 115 to receive, from the network entity, control signaling that configures the set of candidate discrete values associated with the at least one parameter.

In some examples, the communication parameter indication manager 1040 may be configured to cause the UE 115 to receive, from the network entity and in response to the second message, control signaling that indicates one or more communication parameters.

In some examples, the one or more communication parameters include a DRX pattern for the UE, uplink scheduling information, a RBR, or a combination thereof.

In some examples, the available resource manager 1055 may be configured to cause the UE 115 to transmit the request via an available resource, where the one or more communication parameters indicates the available resource for the request.

In some examples, the available resource manager 1055 may be configured to cause the UE 115 to provide an indication of the available resource for the request to the object streaming application. In some examples, the available resource manager 1055 may be configured to cause the UE 115 to obtain, from the object streaming application, an indication to transmit the request via the available resource.

In some examples, the client-side fetching algorithm timing information manager 1060 may be configured to cause the UE 115 to transmit, to the network entity, a third message that indicates updated timing information associated with the client-side fetching algorithm based on the one or more communication parameters indicating a RBR.

In some examples, the client-side fetching algorithm parameter manager 1030 may be configured to cause the UE 115 to transmit, to the network entity after transmission of the second message, a third message that indicates one or more updated parameters associated with the client-side fetching algorithm, where the one or more parameters are indicative of first timing or size information associated with a second request to fetch the object or a second object of the one or more objects, where the second request is after the request, and where the one or more updated parameters are indicative of updated timing or size information associated with the second request.

In some examples, the object fetching manager 1045 may be configured to cause the UE 115 to receive, from the network entity and based on the request, a third message that includes the object in accordance with the client-side fetching algorithm.

A processing system 1020 may include or be a component of one or more chips, systems-on-chips (SoCs), chipsets, packages, components, or devices that individually or collectively constitute or include a processing system. A processing system 1020 may interface with other components of a processing system 1020. For example, operations described with reference to a processing system 1020, or various components thereof, may be performed by or with other such components, including a receiver, a transmitter, a transceiver, a modem, a user interface, a modulator/demodulator, an encoder/decoder, or any combination thereof (such as of the processing system 1020, coupled with the processing system 1020, of a processing system 1020).

By including or configuring a processing system 1020 for operation in a processing system 1020 as described herein, the processing system 1020 may support techniques for improved communication reliability, reduced latency, improved user experience related to reduced processing, reduced power consumption, more efficient utilization of communication resources, improved coordination between devices, longer battery life, and improved utilization of processing capability via improved client side fetching algorithm coordination.

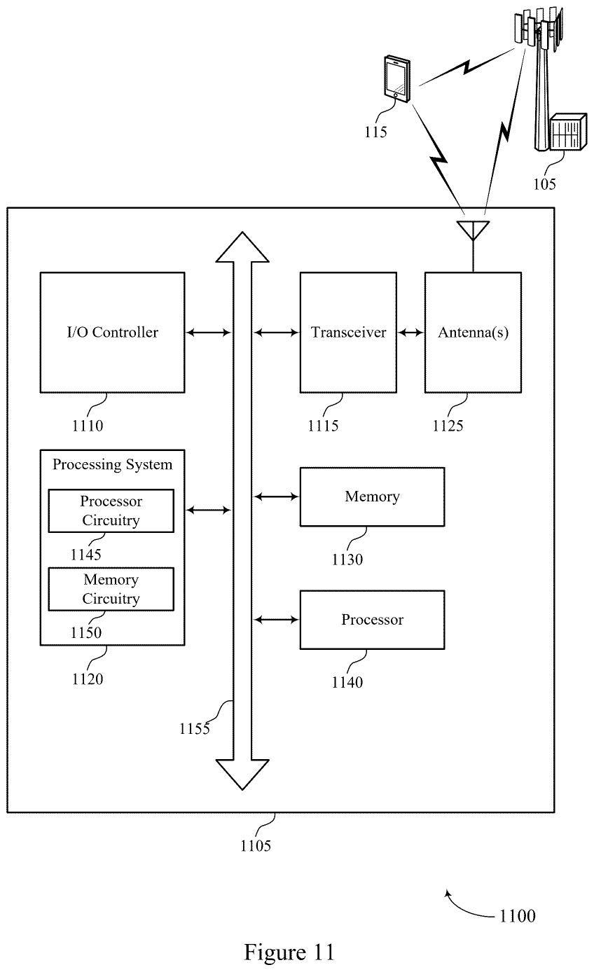

FIG. 11 shows an example of a system 1100 including a device 1105 that supports object streaming application client-side fetching algorithm parameter indication. The device 1105 may be an example of or include components of UE 115. The device 1105 may communicate (such as wirelessly) with one or more other devices (such as network entities 105, UEs 115). The device 1105 may include components for transmitting and receiving communication, which may include a processing system 1120, an input/output (I/O) controller, such as an I/O controller 1110, a transceiver 1115, antenna(s) 1125, a memory 1130, and a processor 1140. Components of the device 1105 may be coupled (such as operatively, communicatively, functionally, electronically, electrically, in electronic communication) a bus 1155.

The transceiver 1115 may support bi-directional communication via antenna(s) 1125, and may support transmission operations, reception operations, or both, as described herein. The transceiver 1115 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 1105). The transceiver 1115 may modulate symbols and provide the modulated symbols to antenna(s) 1125 for transmission, and demodulate symbols from signals received using antenna(s) 1125.

The processor 1140 may be a general-purpose processing component that supports various operations (such as applications) of the device 1105. The memory 1130 may be a general-purpose storage component that stores code executable by the processor 1140. Such code may include instructions that, when executed by the processor 1140, cause the device 1105 to perform various functions (such as to support an application of the device 1105). The I/O controller 1110 may manage inputs and outputs for the device 1105, may manage peripherals not integrated into the device 1105, or may represent a physical connection (such as port) to an external peripheral. The processor 1140 may interact with a modem, a keyboard, a mouse, a touchscreen, or other device (such as via I/O controller 1110). In some implementations, a user may interact with the device 1105 via the I/O controller 1110 or via hardware components controlled by the I/O controller 1110.

The processing system 1120 may be an example of a processing system 140 or a processing system 1020. For example, the processing system 1120 may include processor circuitry 1145 and memory circuitry 1150 that stores code, and may be configured to cause the device 1105 to perform operations that support object streaming application client-side fetching algorithm parameter indication. Although the processing system 1120 is illustrated as a separate component, which may involve a separate chip, chipset, or other module, in some implementations, one or more functions described with reference to the processing system 1120 may be supported by or performed by a transceiver 1115, antenna(s) 1125, a processor 1140, memory 1130, or any combination thereof, such that a processing system 1120 may include one or more of a transceiver 1115, antenna(s) 1125, a processor 1140, memory 1130, or any combination thereof.

By including or configuring the processing system 1120 for operation in the device 1105 as described herein, may support techniques for improved communication reliability, reduced latency, improved user experience related to reduced processing, reduced power consumption, more efficient utilization of communication resources, improved coordination between devices, longer battery life, and improved utilization of processing capability via improved client side fetching algorithm coordination.

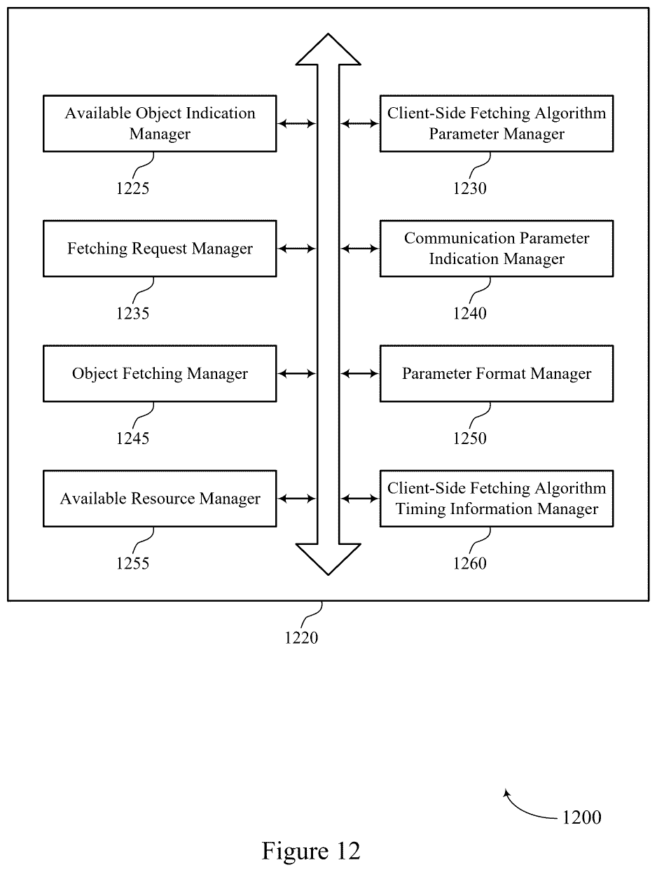

FIG. 12 shows an example 1200 of a processing system 1220 that supports object streaming application client-side fetching algorithm parameter indication. A processing system 1220 may be an example of a processing system 145 (such as network entity 105) and may include an available object indication manager 1225, a client-side fetching algorithm parameter manager 1230, a fetching request manager 1235, a communication parameter indication manager 1240, an object fetching manager 1245, a parameter format manager 1250, an available resource manager 1255, a client-side fetching algorithm timing information manager 1260, or any combination thereof. A processing system 1220, or various component thereof, may be an example of means for performing (such as a means for causing a network entity 105 to perform) various techniques described herein.

The available object indication manager 1225 may be configured to cause the network entity 105 to output, for a UE, a first message that indicates one or more objects available to be fetched from the network entity in accordance with a client-side fetching algorithm at the UE and to be used in accordance with an object streaming application at the UE. The client-side fetching algorithm parameter manager 1230 may be configured to cause the network entity 105 to obtain, in association with the UE, a second message that indicates one or more parameters associated with the client-side fetching algorithm, where the one or more parameters are associated with a timing or a size of a request to fetch an object of the one or more objects. The fetching request manager 1235 may be configured to cause the network entity 105 to obtain, in association with the UE, the request to fetch the object in accordance with the client-side fetching algorithm.

In some examples, the one or more parameters include an RTT associated with the request and a response to the request, a size of the request, a size of the response to the request, a duration between the request and a subsequent request, or any combination thereof.

In some examples, to support obtaining the second message, the fetching request manager 1235 may be configured to cause the network entity 105 to obtain the second message via a header of an uplink message that includes the request.

In some examples, to support obtaining the second message, the fetching request manager 1235 may be configured to cause the network entity 105 to obtain a UAI message that includes the one or more parameters.

In some examples, to support obtaining the second message, the fetching request manager 1235 may be configured to cause the network entity 105 to obtain the second message via a MAC-CE of an uplink message that includes the request.

In some examples, at least one parameter of the one or more parameters includes a range of values.

In some examples, at least one parameter of the one or more parameters includes a discrete value selected from a set of candidate discrete values.

In some examples, the parameter format manager 1250 may be configured to cause the network entity 105 to output, for the UE, control signaling that configures the set of candidate discrete values associated with the at least one parameter.

In some examples, the communication parameter indication manager 1240 may be configured to cause the network entity 105 to output, for the UE and in response to the second message, control signaling that indicates one or more communication parameters.

In some examples, the one or more communication parameters include a DRX pattern for the UE, uplink scheduling information, a RBR, or a combination thereof.

In some examples, the available resource manager 1255 may be configured to cause the network entity 105 to obtain the request via an available resource, where the one or more communication parameters indicates the available resource for the request.

In some examples, the client-side fetching algorithm timing information manager 1260 may be configured to cause the network entity 105 to obtain, in association with the UE, a third message that indicates updated timing information associated with the client-side fetching algorithm based on the one or more communication parameters indicating a RBR.

In some examples, the client-side fetching algorithm parameter manager 1230 may be configured to cause the network entity 105 to obtain, in association with the UE after obtaining the second message, a third message that indicates one or more updated parameters associated with the client-side fetching algorithm, where the one or more parameters are indicative of first timing or size information associated with a second request to fetch the object or a second object of the one or more objects, where the second request is after the request, and where the one or more updated parameters are indicative of updated timing or size information associated with the second request.

In some examples, the object fetching manager 1245 may be configured to cause the network entity 105 to output, for the UE and based on the request, a third message that includes the object in accordance with the client-side fetching algorithm.

A processing system 1220 may include or be an example of one or more chips, SoCs, chipsets, packages, components, or devices that individually or collectively constitute or include a processing system. A processing system 1220 may interface with other components of a network entity 105. For example, operations described with reference to a processing system 1220, or various components thereof, may be performed by or with other such components, including a receiver, a transmitter, a transceiver, a modem, a user interface, a modulator/demodulator, an encoder/decoder, or any combination thereof (such as of the processing system 1220, coupled with the processing system 1220, of a network entity 105). Operations described herein with reference to the processing system 1220, or various components thereof, may be performed by or with other such components, including a CU 160, a DU 165, an RU 170, or any combination thereof. Each of one or more of any of such components, or subcomponents thereof (such as one or more processors, one or more memories), may communicate, directly or indirectly, with one another. The communication may include communication within a protocol layer of a protocol stack, communication associated with a logical channel of a protocol stack (such as between protocol layers of a protocol stack, within a device, component, or virtualized component associated with a network entity 105, between devices, components, or virtualized components associated with a network entity 105), or any combination thereof.

By including or configuring a processing system 1220 for operation in a processing system 1220 as described herein, the processing system 1220 may support techniques for improved communication reliability, reduced latency, improved user experience related to reduced processing, reduced power consumption, more efficient utilization of communication resources, improved coordination between devices, longer battery life, and improved utilization of processing capability via improved client side fetching algorithm coordination.

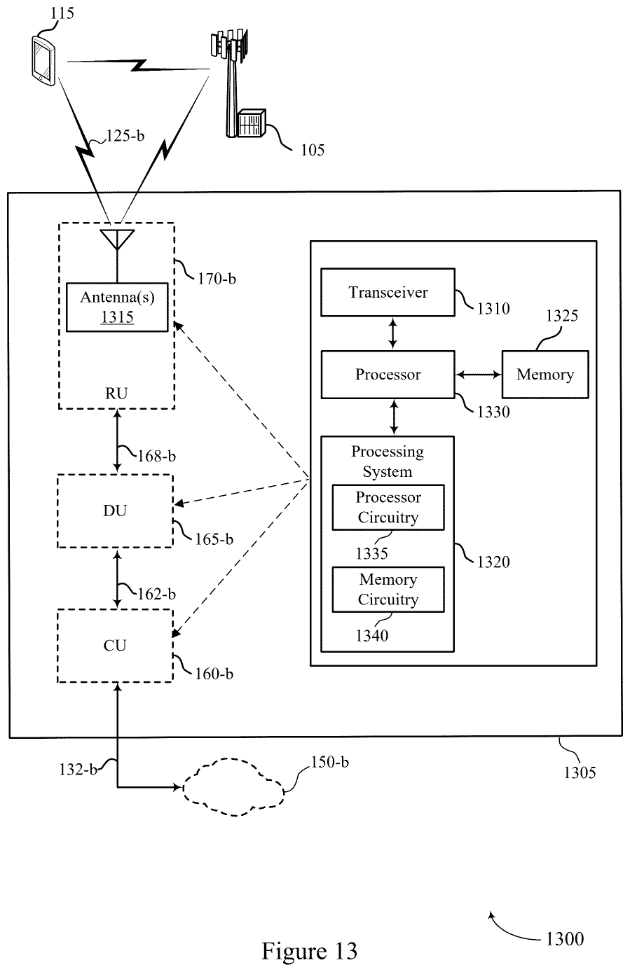

FIG. 13 shows an example of a system 1300 including a device 1305 that supports object streaming application client-side fetching algorithm parameter indication. The device 1305 may communicate (such as via one or more wired interfaces or one or more wireless interfaces) with other network devices or network equipment such as a core network 150-b, other network entities 105, UEs 115, or any combination thereof. The device 1305 may include components for transmitting and receiving communication, which may include a processing system 1320, a transceiver 1310, antenna(s) 1315, a memory 1325, and a processor 1330. Components of the device 1305 may be coupled (such as operatively, communicatively, functionally, electronically, electrically, in electronic communication) via one or more interfaces.

The transceiver 1310 may communicate bi-directionally with another transceiver via wired or wireless links, and may support transmission operations, reception operations, or both, as described herein. The transceiver 1310 may include a modem to modulate and demodulate signals, to provide the modulated signals for transmission (such as via antenna(s) 1315, via a wired interface), and to demodulate received signals (such as received via antenna(s) 1315, received via a wired interface). The transceiver 1310 may be operable to support communication via one or more communication links (such as a communication link 125-b, a backhaul link 132-b, a midhaul link 162-b, fronthaul link 168-b).

The processor 1330 may be a general-purpose processing component that supports various operations (such as applications) of the device 1305. The memory 1325 may be a general-purpose storage component that stores code executable by the processor 1330. Such code may include instructions that, when executed by the processor 1330, cause the device 1305 to perform various functions (such as to support an application of the device 1305).

For examples in which the device 1305 is a network entity 105 in a disaggregated architecture, one or more components of the device 1305 may be located at one or more of a CU 160-b, a DU 165-b, or an RU 170-b, one or more of which may include aspects of the processing system 1320, the processor 1330, the memory 1325, or the transceiver 1310. Functions of the device 1305 may be performed at different components or an operation may be divided between different components (such as different functions being supported by aspects of the CU 160-b, the DU 165-b, or the RU 170-b, the transceiver 1310, the processor 1330, the memory 1325, the processing system 1320, or any combination thereof). For example, the processing system 1320 may be a component of one or more of the CU 160-b, the DU 165-b, or the RU 170-b. In some examples, interfaces between components of device 1305 (such as CU 160-b, DU 165-b, RU 170-b) may support communication at a protocol layer or between protocol layers of a protocol stack.

In some examples, the processing system 1320 may manage aspects of communication with the core network 150-b (such as via a backhaul link 132). For example, the processing system 1320 may manage the transfer of data communication for UEs 115 with a gateway of the core network 150-b. In some examples, the processing system 1320 may manage communication with one or more other network entities 105 and may include a controller or scheduler for controlling communication with UEs 115 (such as in cooperation with the one or more other network entities 105). In some examples, the processing system 1320 may support an interface (such as X2 interface, Xn interface) to provide communication between network entities 105.

The processing system 1320 may be an example of a processing system 145 or a processing system 1220. For example, the processing system 1320 may include processor circuitry 1335 and memory circuitry 1340 that stores code, and the processing system 1320 may be configured to cause the device 1305 to perform operations that support object streaming application client-side fetching algorithm parameter indication. Although the processing system 1320 is illustrated as a separate component, which may involve a separate chip, chipset, or other module, in some implementations, one or more functions described with reference to the processing system 1320 may be supported by or performed by a transceiver 1310, antenna(s) 1315, a processor 1330, memory 1325, or any combination thereof, such that a processing system 1320 may include one or more of a transceiver 1310, antenna(s) 1315, a processor 1330, memory 1325, or any combination thereof. Further, processor circuitry 1335 and memory circuitry 1340 each may be implemented at the device 1305 in accordance with an aggregated architecture, or the processor circuitry 1335 and the memory circuitry 1340 may be implemented at one or more of a CU 160-b, a DU 165-b, or an RU 170-b in accordance with a disaggregated architecture.

By including or configuring the processing system 1320 for operation in the device 1305 as described herein, may support techniques for improved communication reliability, reduced latency, improved user experience related to reduced processing, reduced power consumption, more efficient utilization of communication resources, improved coordination between devices, longer battery life, and improved utilization of processing capability via improved client side fetching algorithm coordination.

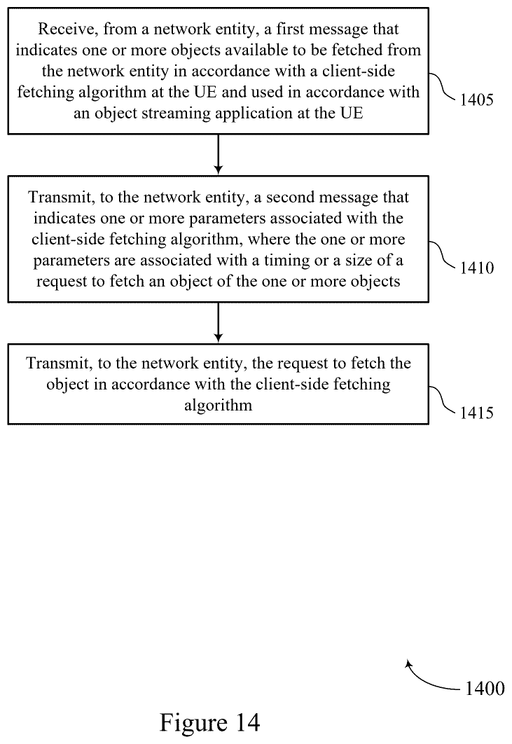

FIG. 14 shows an example of a method 1400 that supports object streaming application client-side fetching algorithm parameter indication. Operations of the method 1400 may be performed by a UE or its components (such as using a processing system configured to cause the UE 115 to perform one or more of the operations) as described herein.

At 1405, the method may include receiving, from a network entity, a first message that indicates one or more objects available to be fetched from the network entity in accordance with a client-side fetching algorithm at the UE and used in accordance with an object streaming application at the UE. In some examples, aspects of the operations of 1405 may be performed by an available object indication manager 1025.

At 1410, the method may include transmitting, to the network entity, a second message that indicates one or more parameters associated with the client-side fetching algorithm, where the one or more parameters are associated with a timing or a size of a request to fetch an object of the one or more objects. In some examples, aspects of the operations of 1410 may be performed by a client-side fetching algorithm parameter manager 1030.

At 1415, the method may include transmitting, to the network entity, the request to fetch the object in accordance with the client-side fetching algorithm. In some examples, aspects of the operations of 1415 may be performed by a fetching request manager 1035.

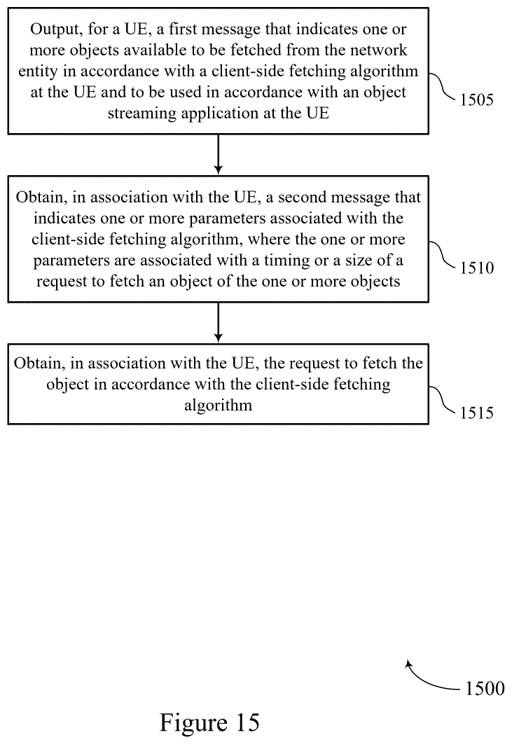

FIG. 15 shows an example of a method 1500 that supports object streaming application client-side fetching algorithm parameter indication. Operations of the method 1500 may be performed by a network entity 105 or its components (such as using a processing system configured to cause the network entity to perform one or more operations) as described herein.

At 1505, the method may include outputting, for a UE, a first message that indicates one or more objects available to be fetched from the network entity in accordance with a client-side fetching algorithm at the UE and to be used in accordance with an object streaming application at the UE. In some examples, aspects of the operations of 1505 may be performed by an available object indication manager 1225.

At 1510, the method may include obtaining, in association with the UE, a second message that indicates one or more parameters associated with the client-side fetching algorithm, where the one or more parameters are associated with a timing or a size of a request to fetch an object of the one or more objects. In some examples, aspects of the operations of 1510 may be performed by a client-side fetching algorithm parameter manager 1230.

At 1515, the method may include obtaining, in association with the UE, the request to fetch the object in accordance with the client-side fetching algorithm. In some examples, aspects of the operations of 1515 may be performed by a fetching request manager 1235.

Implementation examples are described in the following numbered clauses:

Aspect 1: A method for wireless communications at a UE, comprising: receiving, from a network entity, a first message that indicates one or more objects available to be fetched from the network entity in accordance with a client-side fetching algorithm at the UE and used in accordance with an object streaming application at the UE; transmitting, to the network entity, a second message that indicates one or more parameters associated with the client-side fetching algorithm, wherein the one or more parameters are associated with a timing or a size of a request to fetch an object of the one or more objects; and transmitting, to the network entity, the request to fetch the object in accordance with the client-side fetching algorithm.

Aspect 2: The method of aspect 1, wherein the one or more parameters comprise an RTT associated with the request and a response to the request, a size of the request, a size of the response to the request, a duration between the request and a subsequent request, or any combination thereof.

Aspect 3: The method of any of aspects 1 through 2, wherein transmitting the second message comprises: transmitting the second message via a header of an uplink message that comprises the request.

Aspect 4: The method of any of aspects 1 through 2, wherein transmitting the second message comprises: transmitting a UAI message that comprises the one or more parameters.

Aspect 5: The method of any of aspects 1 through 2, wherein transmitting the second message comprises: transmitting the second message via a MAC-CE of an uplink message that comprises the request.

Aspect 6: The method of any of aspects 1 through 5, wherein at least one parameter of the one or more parameters comprises a range of values.

Aspect 7: The method of any of aspects 1 through 5, wherein at least one parameter of the one or more parameters comprises a discrete value selected from a set of candidate discrete values.

Aspect 8: The method of aspect 7, further comprising: receiving, from the network entity, control signaling that configures the set of candidate discrete values associated with the at least one parameter.

Aspect 9: The method of any of aspects 1 through 8, further comprising: receiving, from the network entity and in response to the second message, control signaling that indicates one or more communication parameters.

Aspect 10: The method of aspect 9, wherein the one or more communication parameters comprise a DRX pattern for the UE, uplink scheduling information, a RBR, or a combination thereof.

Aspect 11: The method of any of aspects 9 through 10, further comprising transmitting the request via an available resource, wherein the one or more communication parameters indicates the available resource for the request.

Aspect 12: The method of aspect 11, further comprising: providing an indication of the available resource for the request to the object streaming application; and obtaining, from the object streaming application, an indication to transmit the request via the available resource.

Aspect 13: The method of any of aspects 9 through 12, further comprising: transmitting, to the network entity, a third message that indicates updated timing information associated with the client-side fetching algorithm based at least in part on the one or more communication parameters indicating a RBR.

Aspect 14: The method of any of aspects 1 through 13, further comprising: transmitting, to the network entity after transmission of the second message, a third message that indicates one or more updated parameters associated with the client-side fetching algorithm, wherein the one or more parameters are indicative of first timing or size information associated with a second request to fetch the object or a second object of the one or more objects, wherein the second request is after the request, and wherein the one or more updated parameters are indicative of updated timing or size information associated with the second request.

Aspect 15: The method of any of aspects 1 through 14, further comprising: receiving, from the network entity and based at least in part on the request, a third message that comprises the object in accordance with the client-side fetching algorithm.

Aspect 16: A method for wireless communications at a network entity, comprising: outputting, for a UE, a first message that indicates one or more objects available to be fetched from the network entity in accordance with a client-side fetching algorithm at the UE and to be used in accordance with an object streaming application at the UE; obtaining, in association with the UE, a second message that indicates one or more parameters associated with the client-side fetching algorithm, wherein the one or more parameters are associated with a timing or a size of a request to fetch an object of the one or more objects; and obtaining, in association with the UE, the request to fetch the object in accordance with the client-side fetching algorithm.

Aspect 17: The method of aspect 16, wherein the one or more parameters comprise an RTT associated with the request and a response to the request, a size of the request, a size of the response to the request, a duration between the request and a subsequent request, or any combination thereof.

Aspect 18: The method of any of aspects 16 through 17, wherein obtaining the second message comprises: obtaining the second message via a header of an uplink message that comprises the request.

Aspect 19: The method of any of aspects 16 through 17, wherein obtaining the second message comprises: obtaining a UAI message that comprises the one or more parameters.

Aspect 20: The method of any of aspects 16 through 17, wherein obtaining the second message comprises: obtaining the second message via a MAC-CE of an uplink message that comprises the request.

Aspect 21: The method of any of aspects 16 through 20, wherein at least one parameter of the one or more parameters comprises a range of values.

Aspect 22: The method of any of aspects 16 through 20, wherein at least one parameter of the one or more parameters comprises a discrete value selected from a set of candidate discrete values.

Aspect 23: The method of aspect 22, further comprising: outputting, for the UE, control signaling that configures the set of candidate discrete values associated with the at least one parameter.

Aspect 24: The method of any of aspects 16 through 23, further comprising: outputting, for the UE and in response to the second message, control signaling that indicates one or more communication parameters.

Aspect 25: The method of aspect 24, wherein the one or more communication parameters comprise a DRX pattern for the UE, uplink scheduling information, a RBR, or a combination thereof.

Aspect 26: The method of any of aspects 24 through 25, further comprising: obtaining the request via an available resource, wherein the one or more communication parameters indicates the available resource for the request.

Aspect 27: The method of any of aspects 24 through 26, further comprising: obtaining, in association with the UE, a third message that indicates updated timing information associated with the client-side fetching algorithm based at least in part on the one or more communication parameters indicating a RBR.

Aspect 28: The method of any of aspects 16 through 27, further comprising: obtaining, in association with the UE after obtaining the second message, a third message that indicates one or more updated parameters associated with the client-side fetching algorithm, wherein the one or more parameters are indicative of first timing or size information associated with a second request to fetch the object or a second object of the one or more objects, wherein the second request is after the request, and wherein the one or more updated parameters are indicative of updated timing or size information associated with the second request.

Aspect 29: The method of any of aspects 16 through 28, further comprising: outputting, for the UE and based at least in part on the request, a third message that comprises the object in accordance with the client-side fetching algorithm.

Aspect 30: A UE for wireless communications, comprising a processing system that includes processor circuitry and memory circuitry that stores code, the processing system configured to cause the UE to perform a method of any of aspects 1 through 15.

Aspect 31: A UE for wireless communications, comprising at least one means for performing a method of any of aspects 1 through 15.

Aspect 32: A non-transitory computer-readable medium storing code for wireless communications, the code comprising instructions executable by one or more processors to perform a method of any of aspects 1 through 15.

Aspect 33: A network entity for wireless communications, comprising a processing system that includes processor circuitry and memory circuitry that stores code, the processing system configured to cause the network entity to perform a method of any of aspects 16 through 29.

Aspect 34: A network entity for wireless communications, comprising at least one means for performing a method of any of aspects 16 through 29.

Aspect 35: A non-transitory computer-readable medium storing code for wireless communications, the code comprising instructions executable by one or more processors to perform a method of any of aspects 16 through 29.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
a processing system that includes processor circuitry and memory circuitry that stores code, the processing system configured to cause the UE to:
receive, from a network entity, a first message that indicates one or more objects available to be fetched from the network entity in accordance with a client-side fetching algorithm at the UE and used in accordance with an object streaming application at the UE;
transmit, to the network entity, a second message that indicates one or more parameters associated with the client-side fetching algorithm, wherein the one or more parameters are associated with a timing or a size of a request to fetch an object of the one or more objects; and
transmit, to the network entity, the request to fetch the object in accordance with the client-side fetching algorithm.

2. The UE of claim 1, wherein the one or more parameters comprise a round trip time associated with the request and a response to the request, a size of the request, a size of the response to the request, a duration between the request and a subsequent request, or any combination thereof.

3. The UE of claim 1, wherein, to transmit the second message, the processing system is configured to cause the UE to:
transmit the second message via a header of an uplink message that comprises the request.

4. The UE of claim 1, wherein, to transmit the second message, the processing system is configured to cause the UE to:
transmit an uplink assistance information message that comprises the one or more parameters.

5. The UE of claim 1, wherein, to transmit the second message, the processing system is configured to cause the UE to:
transmit the second message via a medium access control (MAC) control element of an uplink message that comprises the request.

6. The UE of claim 1, wherein at least one parameter of the one or more parameters comprises a range of values.

7. The UE of claim 1, wherein at least one parameter of the one or more parameters comprises a discrete value selected from a set of candidate discrete values.

8. The UE of claim 7, wherein the processing system is further configured to cause the UE to:
receive, from the network entity, control signaling that configures the set of candidate discrete values associated with the at least one parameter.

9. The UE of claim 1, wherein the processing system is further configured to cause the UE to:
receive, from the network entity and in response to the second message, control signaling that indicates one or more communication parameters.

10. The UE of claim 9, wherein the one or more communication parameters comprise a discontinuous reception pattern for the UE, uplink scheduling information, a recommended bit rate, or a combination thereof.

11. The UE of claim 9, wherein the processing system is further configured to cause the UE to:
transmit the request via an available resource, wherein the one or more communication parameters indicates the available resource for the request.

12. The UE of claim 11, wherein the processing system is further configured to cause the UE to:
provide an indication of the available resource for the request to the object streaming application; and
obtain, from the object streaming application, an indication to transmit the request via the available resource.

13. The UE of claim 9, wherein the processing system is further configured to cause the UE to:
transmit, to the network entity, a third message that indicates updated timing information associated with the client-side fetching algorithm based at least in part on the one or more communication parameters indicating a recommended bit rate.

14. The UE of claim 1, wherein the processing system is further configured to cause the UE to:
transmit, to the network entity after transmission of the second message, a third message that indicates one or more updated parameters associated with the client-side fetching algorithm, wherein the one or more parameters are indicative of first timing or size information associated with a second request to fetch the object or a second object of the one or more objects, wherein the second request is after the request, and wherein the one or more updated parameters are indicative of updated timing or size information associated with the second request.

15. The UE of claim 1, wherein the processing system is further configured to cause the UE to:
receive, from the network entity and based at least in part on the request, a third message that comprises the object in accordance with the client-side fetching algorithm.

16. A network entity, comprising:
a processing system that includes processor circuitry and memory circuitry that stores code, the processing system configured to cause the network entity to:
output, for a user equipment (UE), a first message that indicates one or more objects available to be fetched from the network entity in accordance with a client-side fetching algorithm at the UE and to be used in accordance with an object streaming application at the UE;
obtain, in association with the UE, a second message that indicates one or more parameters associated with the client-side fetching algorithm, wherein the one or more parameters are associated with a timing or a size of a request to fetch an object of the one or more objects; and
obtain, in association with the UE, the request to fetch the object in accordance with the client-side fetching algorithm.

17. The network entity of claim 16, wherein the one or more parameters comprise a round trip time associated with the request and a response to the request, a size of the request, a size of the response to the request, a duration between the request and a subsequent request, or any combination thereof.

18. The network entity of claim 16, wherein, to obtain the second message, the processing system is configured to cause the network entity to:
obtain the second message via a header of an uplink message that comprises the request.

19. The network entity of claim 16, wherein, to obtain the second message, the processing system is configured to cause the network entity to:
obtain an uplink assistance information message that comprises the one or more parameters.

20. The network entity of claim 16, wherein, to obtain the second message, the processing system is configured to cause the network entity to:
obtain the second message via a medium access control (MAC) control element of an uplink message that comprises the request.

21. The network entity of claim 16, wherein at least one parameter of the one or more parameters comprises a range of values.

22. The network entity of claim 16, wherein at least one parameter of the one or more parameters comprises a discrete value selected from a set of candidate discrete values.

23. The network entity of claim 22, wherein the processing system is further configured to cause the network entity to:
output, for the UE, control signaling that configures the set of candidate discrete values associated with the at least one parameter.

24. The network entity of claim 16, wherein the processing system is further configured to cause the network entity to:
output, for the UE and in response to the second message, control signaling that indicates one or more communication parameters.

25. The network entity of claim 24, wherein the one or more communication parameters comprise a discontinuous reception pattern for the UE, uplink scheduling information, a recommended bit rate, or a combination thereof.

26. The network entity of claim 24, wherein the processing system is further configured to cause the network entity to:
obtain the request via an available resource, wherein the one or more communication parameters indicates the available resource for the request.

27. The network entity of claim 24, wherein the processing system is further configured to cause the network entity to:
obtain, in association with the UE, a third message that indicates updated timing information associated with the client-side fetching algorithm based at least in part on the one or more communication parameters indicating a recommended bit rate.

28. The network entity of claim 16, wherein the processing system is further configured to cause the network entity to:
obtain, in association with the UE after obtaining the second message, a third message that indicates one or more updated parameters associated with the client-side fetching algorithm, wherein the one or more parameters are indicative of first timing or size information associated with a second request to fetch the object or a second object of the one or more objects, wherein the second request is after the request, and wherein the one or more updated parameters are indicative of updated timing or size information associated with the second request.

29. A method for wireless communications at a user equipment (UE), comprising:
receiving, from a network entity, a first message that indicates one or more objects available to be fetched from the network entity in accordance with a client-side fetching algorithm at the UE and used in accordance with an object streaming application at the UE;
transmitting, to the network entity, a second message that indicates one or more parameters associated with the client-side fetching algorithm, wherein the one or more parameters are associated with a timing or a size of a request to fetch an object of the one or more objects; and
transmitting, to the network entity, the request to fetch the object in accordance with the client-side fetching algorithm.

30. A method for wireless communications at a network entity, comprising:
outputting, for a user equipment (UE), a first message that indicates one or more objects available to be fetched from the network entity in accordance with a client-side fetching algorithm at the UE and to be used in accordance with an object streaming application at the UE;
obtaining, in association with the UE, a second message that indicates one or more parameters associated with the client-side fetching algorithm, wherein the one or more parameters are associated with a timing or a size of a request to fetch an object of the one or more objects; and
obtaining, in association with the UE, the request to fetch the object in accordance with the client-side fetching algorithm.
